(19) United States
(12) Patent Application Publication
(10) Pub. No.: US 2022/0138081 A1
(43) Pub. Date: May 5, 2022

(54) Systems and Methods for Optimization of Application Performance on a Telecommunications Network

(71) Applicant: Innovate5G, Inc., Richardson, TX (US)

(72) Inventors: Rashmi Varma, Richardson, TX (US); Chris Stark, Plano, TX (US)

(21) Appl. No.: 17/515,951

(22) Filed: Nov. 1, 2021

Related U.S. Application Data
(60) Provisional application No. 63/108,812, filed on Nov. 2, 2020.

(51) Int. Cl. G06F 11/36; H04L 12/24; G06N 20/00

(52) U.S. Cl. CPC G06F 11/3612; H04L 41/0813; G06N 20/00; G06F 11/3688; G06F 11/3684

(57) ABSTRACT

Systems, apparatuses, and methods directed to the testing, evaluation, and orchestration of an application's performance when the application is used with a specific network architecture and configuration. A testing, evaluation, and orchestration platform recommends, generates, and executes end-to-end network testcases based on the type and characteristics of the application, and one or more network configuration parameters. The platform may provide performance-specific test measurements for an application gathered from measured network parameters (such as KPIs).

### CROSS REFERENCE TO RELATED APPLICATION

This application claims the benefit of U.S. Provisional Application No. 63/108,812, entitled “Systems and Methods for Optimization of Application Performance on a Telecommunications Network,” filed Nov. 2, 2020, the disclosure of which is incorporated, in its entirety (including the Appendices), by this reference.

### BACKGROUND

As communications network architectures and capabilities change over time, they provide new opportunities for network operators and for end users. These new opportunities may take the form of improved, and in some cases new, services that can be implemented by software applications. For example, as new generations of wireless networks are developed and made available to users, client devices can take advantage of increased bandwidth, decreased latency, and the ability to interact with the network in ways that allow the network to service the needs of an application. In this regard, previous generation of networks were application agnostic and did not adapt to an application and its network resource requirements or characteristics. However, newer and more advanced networks have the capability to be application aware, and this has implications for the types of applications and services that can be provided to users and network administrators. This may include applications being able to access services or network infrastructure functionality that was too slow or could not be taken advantage of with previous client devices and applications.

As part of providing user access to the advantages of new network architectures and capabilities, network owners, network operators, service and application developers may need to evaluate how certain applications and services perform on a specific network when it is configured according to specific parameters or under specific operating conditions. This evaluation may assist developers to optimize the performance of an application when used in conjunction with a specific client device and network configuration. A result of this evaluation or optimization process may be to identify a set of parameters for the application that provide a desired level of service performance for a user accessing the application with a specific device over the network under a set of network operating metrics or conditions. Such an evaluation may also assist a network operator or administrator to determine the impact of supporting a particular application on the network and how best to balance use of the application with quality of service (QoS) obligations the operator has to its customers.

Conventionally, the available software development kits (SDKs) and device test platforms are tailored for specific use-cases. For instance, for the case of an application that will be installed and used on a mobile phone, conventional solutions that allow these to be tested are tailored for a specific device and operating system, e.g., iOS or Android. Only limited testing is performed regarding the application's interaction with the device resources, e.g., memory, battery consumption, processing resources, etc.

However, with the advent of 5G technology, applications are not limited to those installed and accessed by a user from an end users mobile device and may also reside on a server in the network cloud. These cloud-based applications may be consumer-oriented applications such as those found on consumer phones, and (or instead) may be applications for other devices and purposes. These might include, for example, medical devices in the healthcare field, IoT controllers, and applications for specialized verticals such as transportation, enterprise, entertainment, financial, education, or agriculture.

These cloud-based applications may include specialized applications for use in managing a network infrastructure by accessing, monitoring, and configuring network elements and network functions. As another example, a cloud-based application might be used to configure or monitor off-the-shelf hardware. For example, Raspberry Pi, Arduino etc., are typically referred to as COTS (Commercial Off The Shelf) hardware and may be used for embedded applications i.e., an application running on a general-purpose processor on these boards.

There is a need for all interested parties (application developers, service developers, service owners, network owners, and network operators/administrators) to be able to orchestrate or evaluate the performance of an application in a situation as dose as possible to what would be expected in an actual network prior to deploying the application. This is desirable to properly evaluate the performance of an application and the demands placed by the application on a network prior to a full deployment, as those may impact the end-user experience or the allocation of network resources to the application. Post evaluation, network administrators, operators and/or owners can then orchestrate the integration of the service or application into the actual network configuration.

Further, conventional application testing approaches are not intended for, and in most cases, not capable of being used to evaluate the performance of an application within a specific network configuration (referred to as a network “slice” and which may define a specific level of speed, latency, reliability, and security), much less to assist an application developer to optimize the performance of their application for one or more network configurations or allow a network owner or administrator to successfully orchestrate the integration of the application into an actual network.

Thus, systems and methods are needed for more efficiently and effectively enabling the testing and evaluation of the performance of an application when used in a specific network configuration. Embodiments of the disclosure are directed toward solving these and other problems individually and collectively.

### SUMMARY

The terms “invention,” “the invention,” “this invention,” “the present invention,” “the present disclosure,” or “the disclosure” as used herein are intended to refer broadly to all the subject matter described in this document, the drawings or figures, and to the claims. Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the systems, apparatuses, and methods described herein are directed to the testing and evaluation of an application's performance when the application is used with a specific network architecture and configuration. In some embodiments, a testing and evaluation platform recommends, generates, and executes end-to-end network testcases based on the type and characteristics of the application, and one or more network configuration parameters. In some embodiments, the platform may provide performance-specific test measurements for an application gathered from measured network parameters (such as KPIs). The parameters may be collected during a simulation or emulation of the application during its use over the network architecture and with a specific configuration of network parameters. As an example, the described test platform and associated processing methods may provide test metrics with respect to network connection, bandwidth, and latency performance of an application over the configured network. In some embodiments, the platform may provide orchestration for integration of the application into a network for testing or actual deployment purposes.

This information may provide an application developer with a deeper understanding of an application's interaction with the network, and its expected performance under one or more of ideal, best, expected (nominal or standard), or even degraded network operating conditions. This can assist the developer to make performance enhancing changes to one or more of the application's data processing or workflow, resource access and usage, network traffic, enabled or disabled options, features, or default features or operations, among other aspects.

As a non-limiting example, a video streaming application may choose to disable video compression of a 720p or 1080p video while transmitting over a 5G network to provide a better user experience. The impact of this change on the application can be only tested over a live 5G network. Instead of driving around to access a 5G network, a developer may choose to test over the test platform described herein that provides access to a 5G network and to meaningful measurements made in the network. The described test platform can provide a developer with a measurement of the bandwidth consumed over the network so that it may be compared to the available bandwidth in the network. An application developer can then choose to stream a higher fidelity video e.g., HD or 4K based on the bandwidth consumption measured over the live network and with awareness of the direct impact of disabling the compression function.

In some embodiments, the systems and methods described herein provide application integration, application testing, and network performance services through a SaaS or multi-tenant platform. The platform provides access to multiple users, each with a separate account and associated data storage. Each user account may correspond to an application developer, group of developers, network owner, network administrator, or business entity, for example. Each account may access one or more services, an example of which are instantiated in their account and which implement one or more of the methods or functions described.

In one embodiment, the disclosure is directed to a method for enabling the testing, monitoring, and evaluation of the performance of an application or service on a configuration of a telecommunications network. In one embodiment, the method may include the following steps, stages, functions, processes, or operations:
Orchestration/management of application integration into the network from the SaaS platform;
   The orchestration will typically include installation of the application on the prescribed device(s) in the network based on the application profile provided at least in part by the developer or end user;
      This typically includes at least information regarding the device on which an application is expected to execute;
         The information provided for the profile may include the device type and the supporting operating system;
      With 5G networks, applications may execute on one or more of a smartphone, an edge server, another connected device, or be distributed between a user device and edge server;
Automatic generation of one or more testcases for the application;
   Testcases may be generated based on an application profile provided at least in part by a developer or end user;
      This typically includes at least information regarding the service parameters an application is expected to use;
         The information provided for the profile may include the requested network slice type, and the nature of the application (e.g., bursty, continuous, bandwidth intensive, latency sensitive);
      If content streaming is involved, the profile may include the content type and resolution;
      The profile information is used to generate testcases that identify the application device under test in the network, establish the traffic path between the application and users, and activate the appropriate deep packet inspection probes on the various interfaces along the path (as described with reference to FIGS. 12, 13(a), and 13(b));
Automatic execution of the generated testcase(s);
   The application is installed on the appropriate device and executed over an actual, operational 5G network;
      The described Application Performance Evaluation and Application Integration platform and associated data collection and analysis processes may be used with a privately constructed and operated 5G network (such as in a lab setting or a private production enterprise network owned by a business entity) or a publicly available 5G network (such as those operated by telecom companies);
         Note that the full capabilities of the platform may not be available for all publicly available networks—for example, the deep packet inspection (DPI) capabilities may be limited in a public network due to constraints placed upon access to specific interfaces by the network operator;
         However, even in such situations, the user equipment (UE) can be evaluated by a deep packet inspection probe connected to the over the air interface;
         The platform may also be used to integrate applications to public networks if the platform is provided with access and configuration permissions for remote application installation;
      A primary differentiator between 5G networks and 4G is the radio technology. In this regard, 5G networks are of two types: 5G Stand Alone (SA) and 5G Non-Stand Alone (NSA). 5G SA networks contain 5G radio and 5G core, while 5G NSA networks contains 4G radios to latch the initial signal and then transfer the UE connection to a 5G radio, and the core in the network is a 4G EPC (evolved packet) core. In contrast, a 4G network contains a 4G radio and a 4G EPC core;
         “Pure” 5G networks are those that are 5G SA. However, the platform can work both on a 5G NSA as well as a 5G SA network and can extract performance of application over both kinds of networks;
   In some uses, the device on which an application is to be executed may be proprietary or otherwise unable to be obtained—in such situations, the application developer is expected to provide an emulator for the device;
      The emulator is typically installed on an appliance with a cellular radio connectivity to emulate the specialized hardware connected over the network;
   A controller or processor may be used to cause the execution of each generated test case based on device and/or network parameters functionality, etc.;
Network deep packet inspection;
   Deep packet inspection (DPI) probes are pre-installed in the network configuration being tested, that is a live network configuration with interfaces on which the probes are installed. The network configuration may be altered to some degree if needed for testing; however, if a sufficiently different configuration is needed, then the platform may use a different network connected to the platform instead of altering a single network configuration repeatedly. An individual probe may be enabled/disabled based on the requirements of a specific testcase;
      Deep Packet Inspection refers to a process or technique for inspecting IP packet flow in a network by reading IP packet headers. The IP Packet information that is collected can provide (or be used to provide) useful information on established QoS flows, PDU Session IDs, Quality Flow Indicator (QFI), Packet loss, Packet Delay Budget etc.
         Typically, packet capture provides throughput and latency information; however, packet headers that are designed to comply with 3GPP guidelines, metrics, and KPIs provide a way to extract further intelligence from a network using deep packet inspection tools;
KPI and metric collection;
   Metrics are collected from the installed probes and pushed into a time stamped database. The entire network, live or simulation/emulation is clocked off a single clock source to synchronize log collection from the entire “network”. Graphs and other visualizations may be generated using the data collected by the probes for review by a test administrator or developer; and
Report generation and dashboard reporting;
   The report is auto-generated and sent to a cloud platform. The cloud platform updates the relevant dashboards with graphs or other forms of output and makes the results available to the developer or other user of the services;
      Outputs of a testing process may include graphs illustrating the measured bandwidth consumed by an application per millisecond, the observed latency in executing a feature of the application over the network, the application device energy, CPU, and memory consumption, radio parameters showing the quality of a signal connecting the device executing the application under test to the network, and a security analysis of the application. In some embodiments, a video recording of the application under test may be provided;
The graphs or other outputs of the testing process can be correlated to application features or performance by a developer; for example, bandwidth or throughput and observed latencies can be compared between 4G and 5G network execution on the testing platform. In some embodiments, the testing platform may provide testing on 4G as well as 5G networks, and this can help to determine the difference in application performance between metered (4G) and unmetered (5G) network selections on application SDKs;
   A developer may be able to correlate the video of the application under test and the specific times at which a spike is noticed in bandwidth consumption or a measured latency. This will inform the developer of the specific areas in the application that cause network resource usage to increase. The test script and application binary provided by the developer to trigger the application may be overlayed on the graphs to provide markers on where the application is at a given instance in time and what parameter values are observed in the network. Memory and CPU consumption on the application device can also be correlated to network observed values for data being transmitted over the network.

In one embodiment, the disclosure is directed to a system for the testing, monitoring, and evaluation of the performance of an application on a configuration or configurations of a telecommunications network. The system may include a set of computer-executable instructions and an electronic processor or processors. When executed by the processor or processors, the instructions cause the processor or processors (or a device of which they are part) to perform a set of operations that implement an embodiment of the disclosed method or methods.

In one embodiment, the disclosure is directed to a set of computer-executable instructions, wherein when the set of instructions are executed by an electronic processor or processors, the processor or processors (or a device of which they are part) performs a set of operations that implement an embodiment of the disclosed method or methods.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the present disclosure will be described with reference to the drawings, in which:

FIG. 1(a) is a diagram illustrating multiple layers or aspects of the 5G network architecture that may be subject to being evaluated as the network is used with an application under test, in accordance with some embodiments. The diagram also illustrates a 4G network architecture that is used for comparative measurement testing for 4G applications optimized for 5G networks;

FIG. 1(b) is a diagram illustrating the probes in a network that gather the network data recording the application interaction for use in monitoring and evaluating the performance of an application in a specific network configuration, in accordance with some embodiments;

FIG. 2 is a flowchart or flow diagram illustrating a process for testing and evaluating an application's performance when used with a specific network configuration, in accordance with some embodiments;

FIG. 3 is a block diagram illustrating the primary functional elements, components, or sub-systems that may be part of a system or platform used to implement the testing and evaluating of an application's performance when used with a specific network configuration, in accordance with some embodiments;

FIG. 4 is a diagram illustrating elements or components that may be present in a computer device, server, or system configured to implement a method, process, function, or operation as described herein, in accordance with some embodiments;

FIG. 5(a) is a diagram illustrating a SaaS platform or system in which an embodiment of the application testing and evaluation services disclosed herein may be implemented or through which an embodiment of the application testing and evaluation services may be accessed;

FIG. 5(b) is a diagram illustrating the Application Performance Platform Front End interface where a user interacts with the platform, in accordance with some embodiments;

FIG. 6 is a diagram illustrating the platform middleware that performs the testcase generation and testcase execution, in accordance with some embodiments;

FIG. 7 is a diagram illustrating the backend of the platform that contains the live 4G and 5G Standalone (SA) networks, in accordance with some embodiments;

FIG. 8 shows the application interaction with the network function at each layer of the network. This layer wise function is used to measure KPIs for testing and evaluating an application's performance when used with a specific network configuration, in accordance with some embodiments;

FIG. 9(a) is a table showing the 3GPP equivalent parameters that may be used to evaluate application performance over a specific network configuration;

FIG. 9(b) is a table showing the 3GPP equivalent parameters that may be used to evaluate application service performance across various network interfaces;

FIG. 9(c) is a diagram illustrating the network service performance for the application over various network slice configurations for a specific network configuration;

FIG. 10 is a diagram illustrating a list of Measured KPIs per QoS Flow and Network slice for an Application or Service Performance Assessment, in accordance with some embodiments;

FIG. 11 is a table listing Recommended values for QoS Flow KPIs per bearer based on 3GPP standards, in accordance with some embodiments;

FIG. 12 is a diagram illustrating an example of an Application Profile Model (APM) Algorithm or Process Flow, in accordance with some embodiments;

FIG. 13(a) is a diagram illustrating an example of a Testcase Profile Model (TPM) Algorithm or Process Flow, in accordance with some embodiments;

FIG. 13(b) is a diagram illustrating an example of a Testcase Profile Generation Process, in accordance with some embodiments;

FIG. 14 is a diagram illustrating an example of a Performance Profile Generation Process, in accordance with some embodiments;

FIGS. 15(a) through 15(d) are diagrams illustrating examples of a Viable Performance Assurance Dashboard for an Application Performance Test, in accordance with some embodiments; and

FIGS. 16(a) through 16(f) are diagrams illustrating examples of a Plug and Play Performance Assurance Dashboard generated for an Application under test, in accordance with some embodiments.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems and methods described herein provide application integration, application testing, and network performance services through a SaaS or multi-tenant platform. The platform provides access to multiple users, each with a separate account and associated data storage. Each user account may correspond to an application developer, group of developers, network administrator, or business entity, for example. Each account may access one or more services, an example of which are instantiated in their account and which implement one or more of the methods or functions described.

Embodiments of the disclosure are directed to systems, apparatuses, and methods for the testing and evaluation of an application's performance when the application is integrated with a specific network architecture, configuration, and service. This is a more complex endeavor than it might appear at first, as there are several interrelated factors:
There are three broad classes of applications that may be considered:
   those for end-users that are executed on top of a network architecture;
   native 5G applications that interact with the control layer of a network to request network resources; and
   those for use by network administrators or operators that are executed within a network architecture, such as for network monitoring, security, and management;
There are multiple network configurations, with each described by a specific set of parameters or variables. These parameters or variables may include, but are not limited to:
   Bandwidth;
   Network Protocol
   Frequency (bands);
   Network Slices;
      A network slice is a set of prescribed parameters for the network to support service multi-tenancy. A slice is an end-to-end description rather than just a component or device parameter. In this respect, a slice encompasses multiple components or devices along an end-to-end path. For example, a radio-mec-core slice provides a prescribed Service Level Agreement (SLA) based on Service Level Requirement (SLR) i.e., a given amount of bandwidth, latency restrictions and number of devices or users using the slice. The slice is used to build an end-to-end service so that an application may provide service level differentiation for different classes of subscribers. As examples:
         eMBB—enhanced Massive BroadBand Network Slice Type has the following Service Level Requirement (SLR):
         high bandwidth >=10 Gbps and
         high throughput of the network >10 Gbps with
         high data rates >10 Gbps
         URLLC—Ultra Reliable Low Latency Communications Network Slice Type has the following Service Level Requirement (SLR):
         latency <=1 ms
         mMTC—massive Machine Type Communication Network Slice Type has the following Service Level Requirement (SLR):
         battery life=10 years;
         coverage penetration=164 dB with
         throughput=160 bits per second;
         coverage density==million devices in a square mile;
         round-trip latencies <10 seconds with
         payloads=20 bytes
      A Network Slice Type may be a combination, such as eMBB+URLLC or URLLC+mMTC;
There are three broad categories of users, each with potentially different interests and requirements:
   Network administrators;
   Application developers;
   End-users of an application.

To properly address these factors and the various combinations, in addition to providing an Application Performance Evaluation and Application Integration platform or system, some embodiments provide the following functions or capabilities:
Correlating application features or performance characteristics to specific network metrics or measurable quantities;
Collecting network metrics using a client embedded in a network element (such as a server) with the ability to discover network topology, decide where to insert network probes for data collection, and access the probes to acquire operational metrics in real-time and determine network performance during use of an application and its features; and
Managing application integration—enable application life cycle management through continuous integration of new application releases by automating installation of the application in previously deployed networks after the performance evaluation and certification process of the application is completed.

As mentioned, there are three primary classifications or categories of applications that may be tested:

### Over the Top (OTT) Applications

This class of applications use the network as a content delivery pipeline. These applications consume bandwidth on the network and may or may not be latency sensitive. They may require a quality of experience (QoE) or quality of service (QoS) evaluation over a network based on the bandwidth consumption and latency behavior of the application in relation to the bandwidth and latency capacity of the network. Examples of this category of application include YouTube, Netflix, Facebook, Messenger, and Whatsapp.

### Native 5G Applications

This class of applications interact with the network to request network resources. The network resources may be used in different configurations to create multiple service classifications for an application, and with that different levels of quality of experience for a user interacting with the application. The application test services are performed on a slice type requested from the network, and it is determined if that allows the application to operate properly based on the network resources granted. In some embodiments, native 5G applications may request a network slice in terms of one or more of the following parameters: eMBB (enhanced Massive Broadband), mMTC (massive Machine Type Connect), URLLC (Ultra Reliable Low Latency Communication), or a combination of them: eMBB+URLLC or mMTC+URLLC. V2X applications and XR (Mixed Reality, Virtual Reality) applications are examples of native 5G applications.

### Network Applications

This class of applications are built for purposes of Network Management, Network Operations, Network Security, and related functions. The 5G networks are for the first time open to third-party applications that may be added to the Network appliances. This further illustrates how third-party applications benefit from access to a network environment where the applications can be tested before production and deployment. Examples of these applications are machine learning models that organize radio resources based on enrichment data, where enrichment data is data received from outside the network, e.g., from external resources such as websites, internet directories, data collection sites, event management sites, etc.

Note that several 5G network bandwidth classifications may exist. For instance:
5G exists in low band 600-850 MHz, referred to as low-band 5G that provides speeds slightly higher than 4G LTE networks;
5G exists in mid band between 1 and 6 GHz and most world-wide networks reside in this band, referred to as mid-band 5G that provides high speeds and better coverage than millimeter wave; and
5G exists in high band 25-39 GHz, referred to as millimeter wave (mm wave) that provides the highest speeds in Gbps with reduced coverage compared to mid-band.
   In general, almost any of the described classes of applications can reside in any of the 5G spectrum networks. Each application should ideally be tested and evaluated in the specific spectrum the application is expected to be executed over, examining the amount of bandwidth (speed) available for the application to use based on the type of network. This makes it important for the application to be tested on a test network that provides access to each of the above spectrum bands, and preferably with one access point or contact (for wireless connectivity).

Since a 5G network is application aware and applications can request network resources, application requests for a network slice (resource) should be tested with the network, along with the network slice grant. Note that testing over Wi-Fi does not suffice, because Wi-Fi does not provide the speeds available with 5G and does not provide mobility management functions used to guarantee a level of experience for a user of an application.

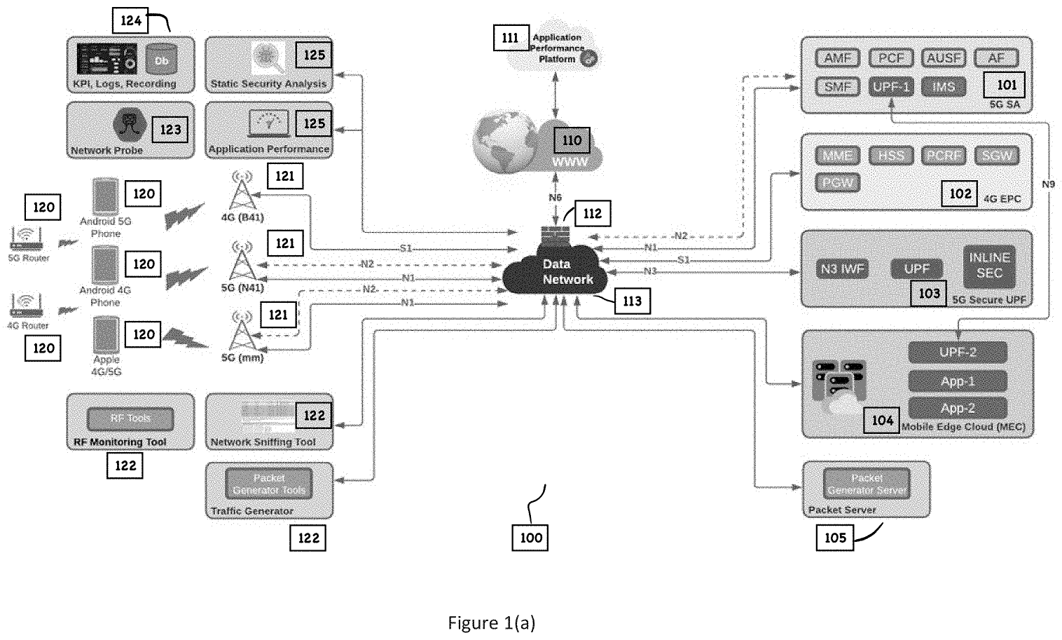

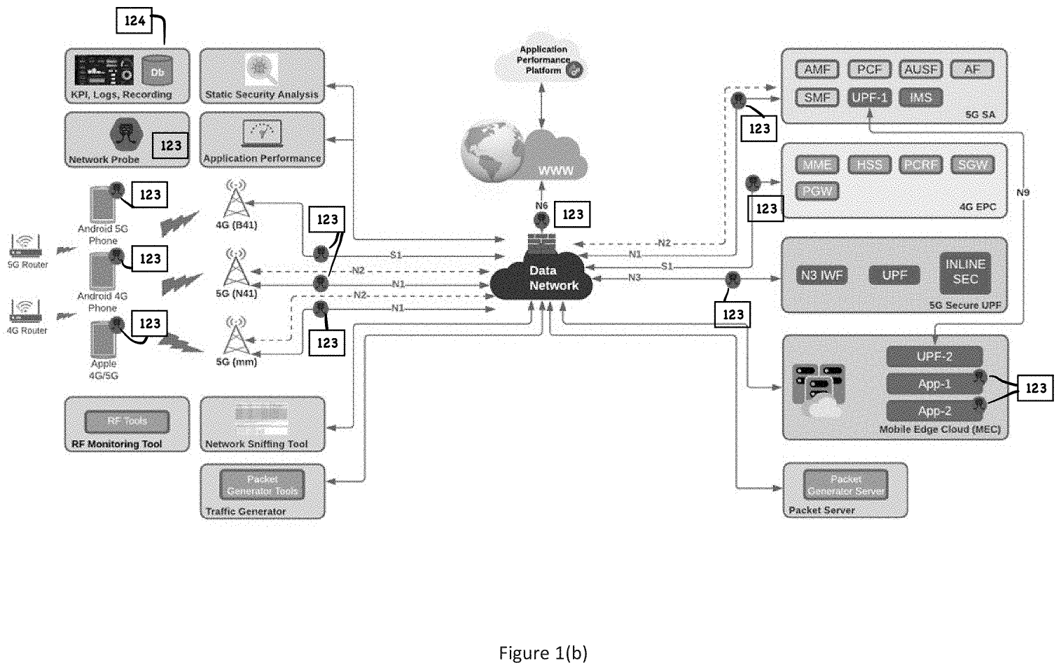

FIG. 1 is a diagram illustrating multiple layers or aspects of the 5G network architecture 100 that may be subject to being evaluated as the network is used with an application under test, in accordance with some embodiments. The diagram also illustrates a 4G network architecture that is used for comparative measurement testing for 4G applications optimized for 5G networks. As shown in the figure, the diagram includes various components of a wireless (4G and 5G) Network with the indicated connections. These include the following:
UE—User Equipment 120 which can be a smart phone, IoT sensor, IoT device including an IoT aggregator, robotic or autonomous machine etc.;
Radio—Wireless transceiver 121 sending radio waves with 5G NR or 4G signaling as defined by 3GPP Release 15 and Release 16;
Cell Site Router—Routing IP traffic generated from radio 121 towards the multi-access edge compute (MEC) 104 and/or network core;
Multi-access Mobile Edge Compute (MEC)—Edge Compute server 104 that hosts applications and algorithms on the edge of the network;
5G SA Core—Network 5G Core 101 performing authentication and subscription services for UEs 120 connecting to the network, establishment of the user data path, mobility management, network slice functions and management, billing and charging management and gateway interconnectivity to the internet (www) 110;
4G EPC—Network 4G Evolved Packet Core 102 providing functionalities of Subscriber information, Authentication, billing and charging management and gateway interconnectivity to the internet (www) 110;
5G UPF—Supporting the CUPS architecture, separation of the User Plane Function (UPF). In the case of a 5G Cloud Core, UPF 103 can provide on premise functionality that provides low latency to applications. UPF 103 can also be separated to reside on MEC 104, to provide MEC applications with low latency network connectivity.

FIG. 1(b) is a diagram illustrating the probes 123 in a network that gather the network data recording the application interaction for use in monitoring and evaluating the performance of an application in a specific network configuration, in accordance with some embodiments. The figure identifies the network probe 123 locations that may be used for deep packet inspection where network data is captured to extract application interaction with the network. Data from these probes 123 is moved over a network bus to a centralized database 124 where the recorded measurements are stored for further processing by metric calculators to construct application performance dashboards 124.

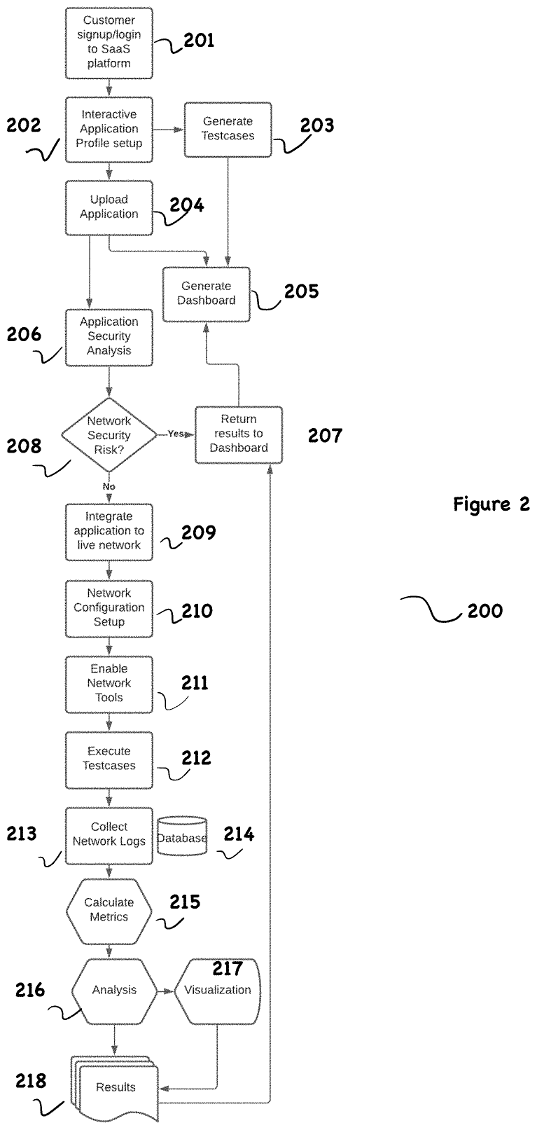

FIG. 2 is a flowchart or flow diagram illustrating a process for testing and evaluating an application's performance when used with a specific network configuration, in accordance with some embodiments. As suggested by the figure, once the user setups the application profile through an interactive form 202 on the platform, the testcases are auto-generated 203 for the application testing over a network configuration. The network configuration 210 could be setup as a 5G network and/or a 4G network.

Based on the network configuration required to auto-run the testcases, the application is integrated 209 into the respective network. Before the application is integrated into the network, application undergoes a security analysis 206 to determine the security risk of installing the application in the desired network appliance. An application may be installed on a user equipment such as smart phone, a special user provided emulator connected to the network over a wireless interface, commercial off the shelf hardware such as a Raspberry Pi or Arduino, an edge compute server, or a network appliance.

The required tools 211 in the network are enabled for the testcases to be executed 212. The logs are collected from the tools 213 and stored in a database 214 for further calculation and analysis. Visualization graphs 217 are built using the analysis 216 and calculated data. These results 218 and logs are returned to the user dashboard 207 to show the results of testcase execution and metrics collected and analysis performed.

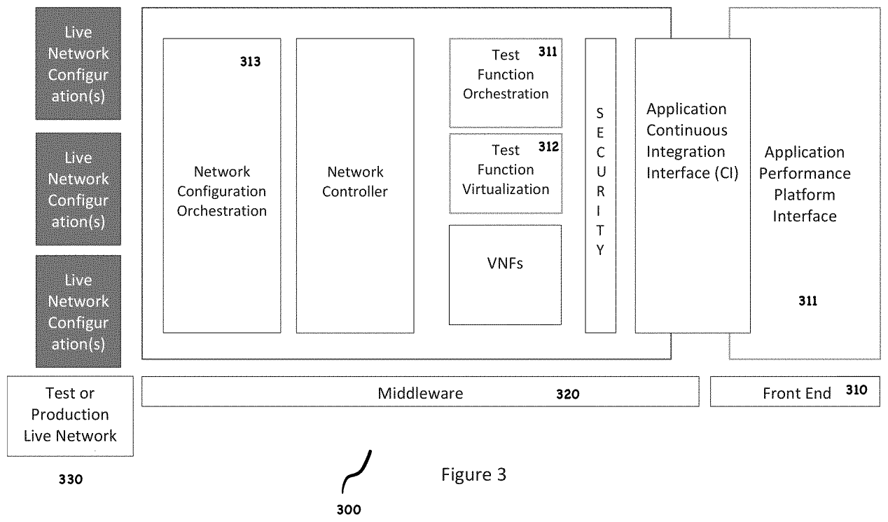

FIG. 3 is a block diagram 300 illustrating the primary functional elements, components, or sub-systems that may be part of a system or platform used to implement the testing and evaluating of an application's performance when used with a specific network configuration, in accordance with some embodiments. As suggested by the figure, the platform architecture may be sub-divided into front-end 310, middleware 320 and back-end 330.

The front-end 310 is implemented as a SaaS platform in the cloud providing each access to users through account signups and logins. The middleware 320 is implemented in a network environment on servers providing functions of testcase generation, automation, and orchestration 311 along with network orchestration 313 (MANO) to setup the required network configuration as required by the auto-generated testcases. The back-end 330 is implemented as a live 4G and/or 5G network that is slice capable with complete setup of User Equipment, Radio, Routing equipment and 5G and 4G core services, along with edge cloud servers available to host mobile edge applications.

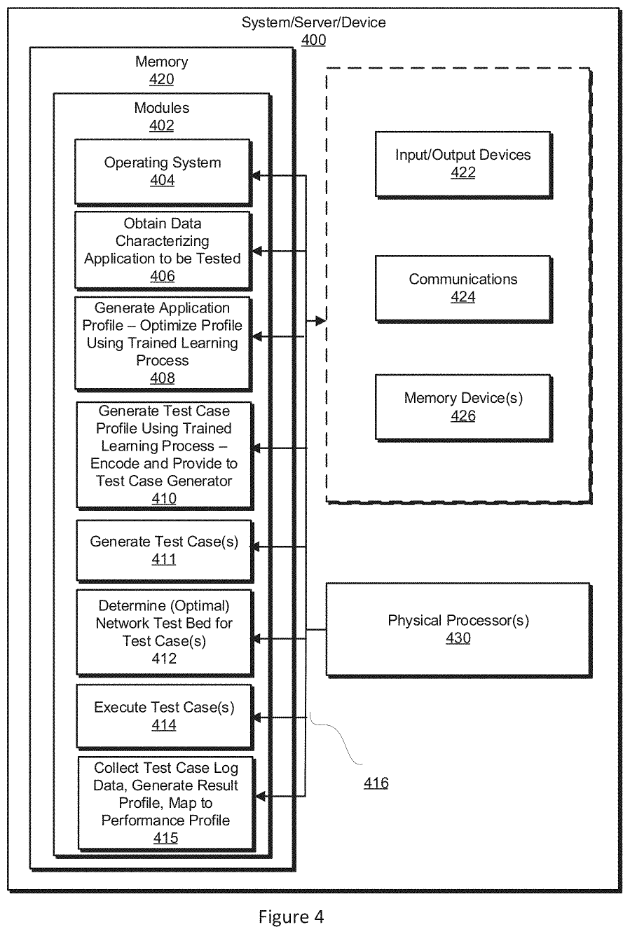

FIG. 4 is a diagram illustrating elements or components that may be present in a computer device, server, or system 400 configured to implement a method, process, function, or operation in accordance with some embodiments. As noted, in some embodiments, the disclosed system and methods may be implemented in the form of an apparatus that includes a processing element and set of executable instructions. The executable instructions may be part of a software application and arranged into a software architecture. In general, an embodiment may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

Each application module or sub-module may correspond to a particular function, method, process, or operation that is implemented by execution of the instructions contained in the module or sub-module. Such function, method, process, or operation may include those used to implement one or more aspects, techniques, components, capabilities, steps, or stages of the described system and methods. In some embodiments, a subset of the computer-executable instructions contained in one module may be implemented by a processor in a first apparatus and a second and different subset of the instructions may be implemented by a processor in a second and different apparatus. This may happen, for example, where a process or function is implemented by steps that occur in both a client device and a remote server or platform.

A module may contain computer-executable instructions that are executed by a processor contained in more than one of a server, client device, network element, system, platform or other component. Thus, in some embodiments, a plurality of electronic processors, with each being part of a separate device, server, platform, or system may be responsible for executing all or a portion of the instructions contained in a specific module. Thus, although FIG. 4 illustrates a set of modules which taken together perform multiple functions or operations, these functions or operations may be performed by different devices or system elements, with certain of the modules (or instructions contained in those modules) being associated with those devices or system elements.

The function, method, process, or operation performed by the execution of instructions contained in a module may include those used to implement one or more aspects of the disclosed system and methods, such as for:
Obtaining Data Characterizing an Application to be Tested and Evaluated;
Generating an Application Profile;
   Optimizing or revising the profile using a trained learning process;
Generating a Test Case Profile;
   This may be performed using a trained learning process;
   The test case profile is encoded and provided to a test case generator function;
Generating Test Case(s);
Determining an optimal (or desired) network test bed for each test case;
Executing the test case(s);
Collecting and processing log data from the execution of the test case(s) and generating a results profile;
   Mapping or correlating to a performance profile for the application and providing to the application developer; and
   Generating suggested optimization or operational improvements (if relevant) to make the application execute more efficiently on the network.

As shown in FIG. 4, system 400 may represent a server or other form of computing or data processing device. Modules 402 each contain a set of executable instructions, where when the set of instructions is executed by a suitable electronic processor (such as that indicated in the figure by “Physical Processor(s) 430”), system (or server or device) 400 operates to perform a specific process, operation, function, or method. Modules 402 are stored in a memory 420, which typically includes an Operating System module 404 that contains instructions used (among other functions) to access and control the execution of the instructions contained in other modules. The modules 402 in memory 420 are accessed for purposes of transferring data and executing instructions by use of a “bus” or communications line 416, which also serves to permit processor(s) 430 to communicate with the modules for purposes of accessing and executing a set of instructions. Bus or communications line 416 also permits processor(s) 430 to interact with other elements of system 400, such as input or output devices 422, communications elements 424 for exchanging data and information with devices external to system 400, and additional memory devices 426.

As an example, Obtain Data Characterizing Application to be Tested Module 406 may contain instructions that when executed perform a process to obtain from an application developer certain information used to configure and execute the Application Performance Evaluation and Application Integration processes. This may be done through a series of questions that are logically arranged to obtain the information based on answers to questions or data provided.

Generate Application Profile—Optimize Profile Using Trained Learning Process Module 408 may contain instructions that when executed perform a process to generate a profile of the application based on the developer's inputs and if needed, optimize or revise that profile using a trained learning process or model.

Generate Test Case Profile Using Trained Learning Process—Encode and Provide to Test Case Generator Module 410 may contain instructions that when executed perform a process to generate a test case profile based on the application profile using a trained learning process or model, encode the test case profile and provide the encoded profile to a test case generator function.

Generate Test Case(s) Module 411 may contain instructions that when executed perform a process to generate one or more test cases for the application that will determine its operation and performance in a specified network configuration.

Determine Optimal (or Desired) Network Test Bed for Test Case(s) Module 412 may contain instructions that when executed perform a process to determine a network configuration for execution of the test case or cases. In some embodiments, this may be the optimal configuration, while in others it may be a sub-optimal configuration, such as one intended to evaluate the performance of the application during a network connectivity or bandwidth problem.

Execute Test Case(s) Module 414 may contain instructions that when executed perform a process to execute the one or more test cases within the specified network test bed and configuration.

Collect Test Case Log Data, Generate Result Profile, Map to Performance Profile Module 415 may contain instructions that when executed perform a process to collect log or other data produced by the application and testing processes during testing of the application, process that data to produce a test result profile, map the test results to the application performance, and make that information and data available to the developer in one or more forms (such as the displays and graphs described herein or various tables or metrics).

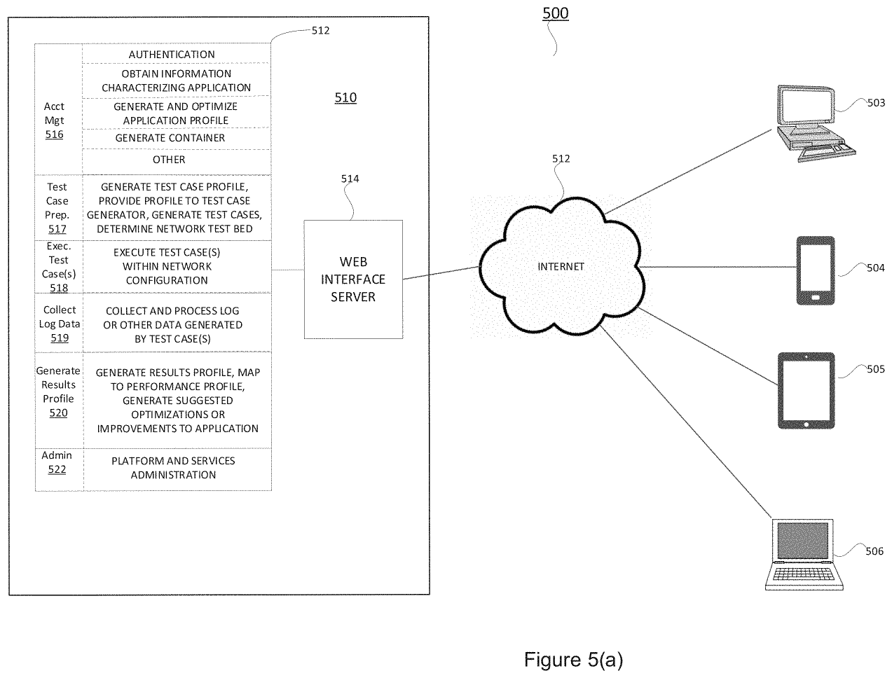

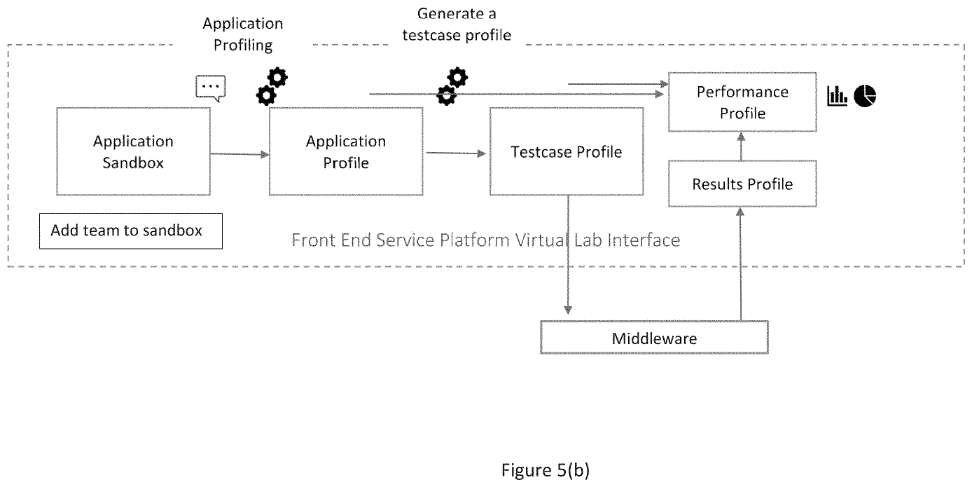

In some embodiments, the functionality and services provided by the system and methods described herein may be made available to multiple users by accessing an account maintained by a server or service platform. Such a server or service platform may be termed a form of Software-as-a-Service (SaaS). FIG. 5(a) is a diagram illustrating a SaaS platform or system in which an embodiment of the application testing and evaluation services disclosed herein may be implemented or through which an embodiment of the application testing and evaluation services may be accessed.

In some embodiments, the application testing and evaluation system or services described herein may be implemented as micro-services, processes, workflows, or functions performed in response to the submission of an application to be tested. The micro-services, processes, workflows, or functions may be performed by a server, data processing element, platform, or system. In some embodiments, the application testing and evaluation services may be provided by a service platform located “in the cloud”. In such embodiments, the platform may be accessible through APIs and SDKs. The functions, processes and capabilities described herein and with reference to the Figures may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

In accordance with the advantages of an application service provider (ASP) hosted business service system (such as a multi-tenant data processing platform), users of the services described herein may comprise individuals, businesses, stores, organizations, etc. A user may access the application testing and evaluation services using any suitable client, including but not limited to desktop computers, laptop computers, tablet computers, scanners, smartphones, etc. In general, any client device having access to the Internet may be used to provide an application to the platform for processing. Users interface with the service platform across the Internet 512 or another suitable communications network or combination of networks. Examples of suitable client devices include desktop computers 503, smartphones 504, tablet computers 505, or laptop computers 506.

Application Performance Evaluation and Application Integration system 510, which may be hosted by a third party, may include a set of application evaluation and integration services 512 and a web interface server 514, coupled as shown in FIG. 5(a). It is to be appreciated that either or both the application testing services 512 and the web interface server 514 may be implemented on one or more different hardware systems and components, even though represented as singular units in FIG. 5(a). Application Testing and Evaluation services 512 may include one or more functions or operations for the testing and evaluation of a provided application with regards to its performance and operation when executed within a specific network configuration.

In some embodiments, the set of services available to a user may include one or more that perform the functions and methods described herein for application testing, evaluation, and reporting of application performance results. As discussed, the functions or processing workflows provided using these services may be used to perform one or more of the following:
Obtaining Data Characterizing an Application to be Tested and Evaluated;
Generating an Application Profile;
   Optimizing or revising the profile using a trained learning process;
Generating a Test Case Profile;
   This may be performed using a trained learning process;
   The test case profile is encoded and provided to a test case generator function;
Generating Test Case(s);
Determining an optimal (or desired) network test bed for each test case;
Executing the test case(s);
Collecting and processing log data from the execution of the test case(s) and generating a results profile;
   Mapping or correlating results profile to a performance profile for the application and providing to the application developer;
   Generating suggested optimization or operational improvements (if relevant) to make the application execute more efficiently on the network.

As examples, in some embodiments, the set of application testing, evaluation, and reporting functions, operations or services made available through the platform or system 510 may include:
Account management services 516, such as
   a process or service to authenticate a user/developer wishing to submit an application for testing and evaluation;
   a process or service to obtain data and information characterizing an application to be tested and evaluated from the developer (in some cases by generating a set of questions dynamically in response to the developer's responses to previous questions);
   a process or service to generate and optimize an application profile;
   a process or service to generate a container or instantiation of the application testing and evaluation processes for the subject application; or
   other forms of account management services.
Test case profile preparation and generation of test cases processes or services 517, such as
   a process or service to generate a test case profile for the application;
   a process or service to provide the test case profile to a test case generator;
   a process or service to generate the test case or cases;
   a process or service to determine an optimal (or sub-optimal if desired for purposes of evaluation) network test bed or configuration for the test case or cases;
Execute test case(s) processes or service 518, such as
   a process or service to execute the one or more test cases to determine the operation and performance of the application under test when executed within the specified network configuration;
Collect and process log data (or other relevant data) generated by test case(s) processes or services 519, such as
   processes or services that collect log or other relevant data generated by the application, the testing functions, and/or a model of the network as configured for the test case and process that data to make it more effectively illustrate the operation and performance of the application when executed within the specified network configuration;
Generate results profile processes or services 520, such as
   a process or service to map or correlate the results profile to a performance profile for the application and provide to the application developer;
   a process or service to generate suggested optimization(s) or operational improvements (if relevant) to make application execute more efficiently on the network; and
administrative services 522, such as
   a process or services to enable the provider of the Application Performance Evaluation and Application Integration services and/or the platform to administer and configure the processes and services provided to users/developers, such as by altering workflows for application testing, altering the logic or models used to generate an application profile or test case profile, etc.

FIG. 5(b) is a diagram illustrating the Application Performance Platform Front End interface where a user interacts with the platform, in accordance with some embodiments. As shown in the figure, in an example usage, a User brings an application to the application sandbox. An admin user can also add a team to the application sandbox. The User builds an application profile and adds an application binary file for testing to the platform. The User builds an application profile for the newly added application binary. The User may add several versions of the same application.

Based on the application profile, the platform generates a testcase profile, a performance profile, and a results profile. These profiles are used to generate the application results dashboard. The dashboard shows the status of the testcase execution based on the testcase profile. The performance profile is used to create 3 separate evaluations for (1) viable performance, (2) plug and play performance, and (3) predictable performance. The results profile lays out the metrics collected for the testcase profile and performance profile.

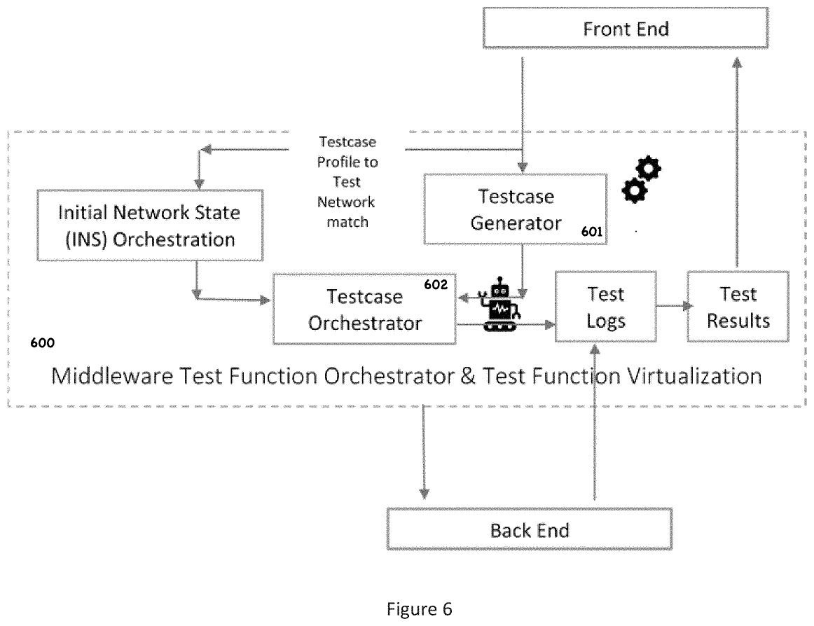

FIG. 6 is a diagram illustrating the platform middleware 600 that performs the testcase generation 601 and testcase execution 602, in accordance with some embodiments. As suggested by the figure, the middleware virtualizes the test function to interact with a network orchestration software that establishes the network configuration and all the network initialization parameters and starts the testcase auto execution. The middleware testcase execution passes information to an RPA agent in the back end for actual testcase execution over a live network.

The test results returned from calculated metrics and analysis by the backend are used by the middleware to generate visualization graphs. Metrics, logs, and graphs are packaged by the middleware and sent to the front end for display on the dashboard based on the results profile, performance profile and testcase profile generated by the front-end platform.

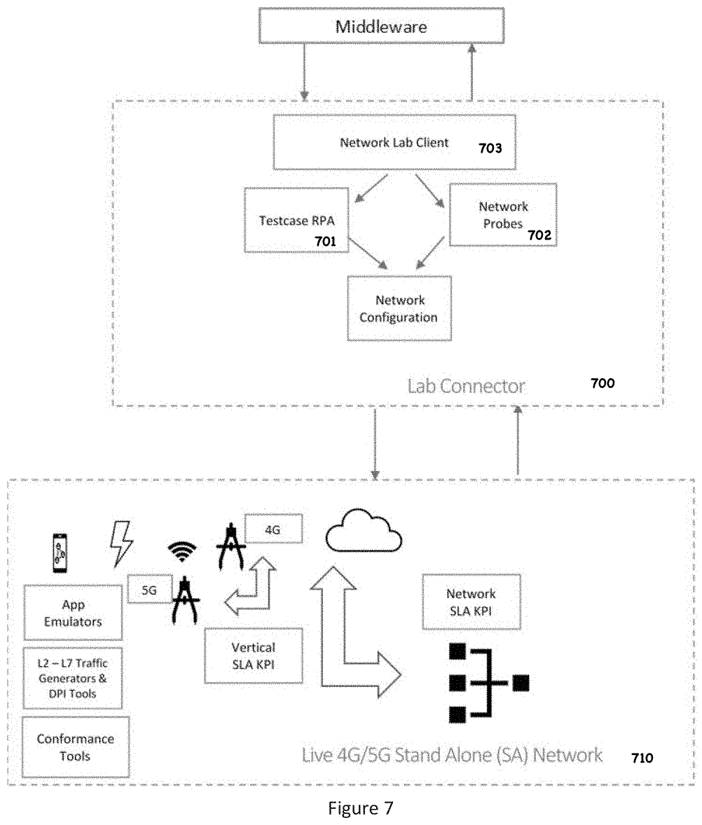

FIG. 7 is a diagram illustrating the backend of the platform 700 that contains the live 4G and 5G Standalone (SA) networks 710, in accordance with some embodiments. As suggested by the figure, there can be several networks connected to the back end of the platform. These networks may have different network configurations. Further, the networks could be test networks or production networks, and may be specialized networks for specific use cases, such as industry 4.0, v2x, healthcare, etc.

The back end also contains a component which interacts with the testcase orchestrator in the middleware, referred to as Testcase RPA (Robotic Process Architecture) 701. The RPA is an agent responsible for network command execution over a live network. It also contains the tools, for example, network probes 702 and log collection connectors that collect the data into a time stamped database for metric calculation and analysis. This calculated metric and analysis is passed to the middleware for visualization generation by middleware. Each network that is added to the test bed contains a back-end platform which hosts the tools and components for a successful application performance test execution.

The cloud-based application performance evaluation and integration platform described herein provides access to application developers and test assurance companies to test an application over a live network. The testing furnishes metrics and KPIs that enable application developers to correlate application features and behavior to performance characteristics observed in the network for the application under test. The deep packet inspection tools that are used to collect intelligence from the network about the application interaction are not provided in conventional live networks and such networks do not publish their performance KPIs for use externally.

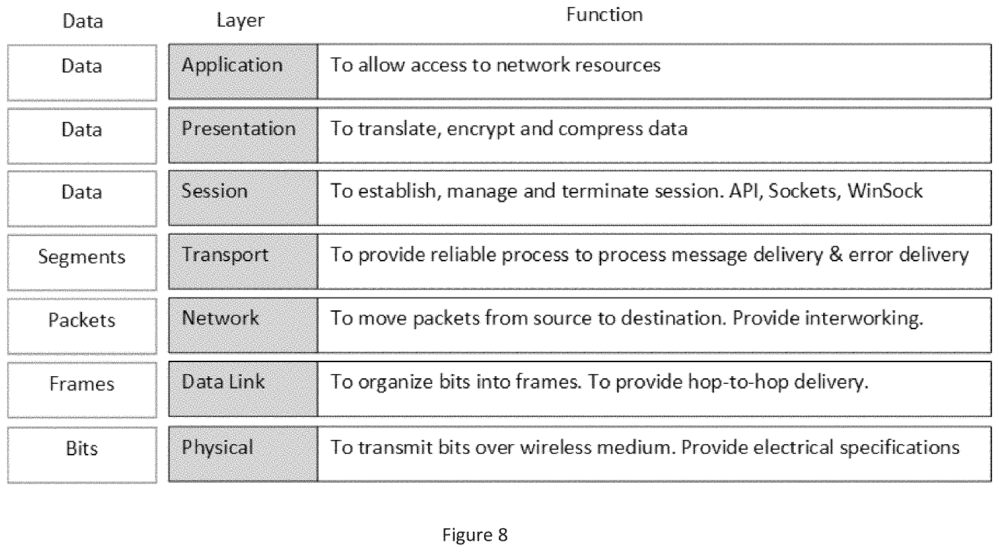

FIG. 8 shows the application interaction with the network function at each layer of the network and indicating how the KPI is measured for use in testing and evaluating an application's performance when used with a specific network configuration, in accordance with some embodiments. The table shows the vertical KPI extraction for each layer of network function that the application generated packet interacts with. The figure therefore shows the Network Layer Function based on which deep packet inspection of the vertical KPIs is based. Application data, once received or transmitted by the application, is analyzed over various layers as the network performs its function to transmit the application data using network resources. This model thus refers to the vertical KPI extraction that is performed to analyze application performance over a network.

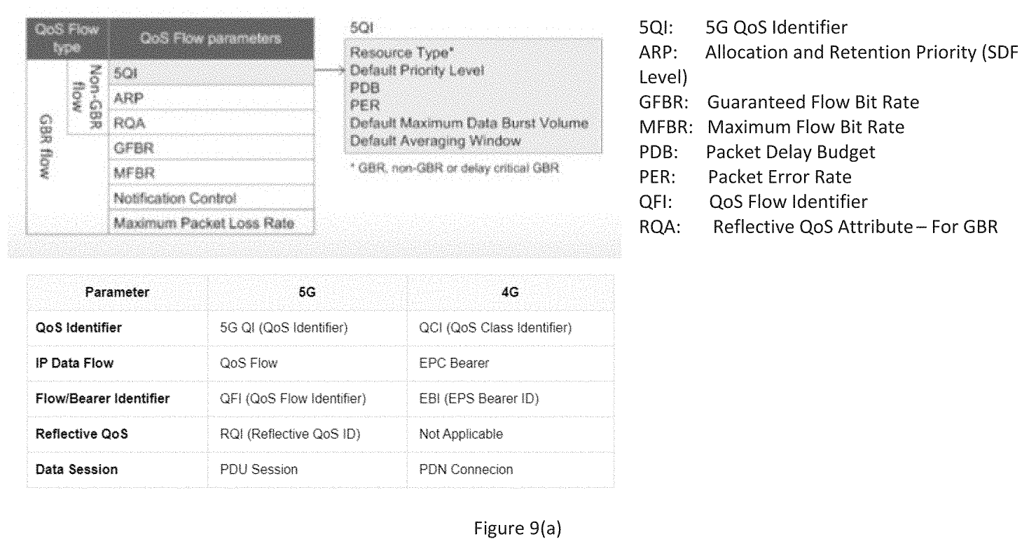

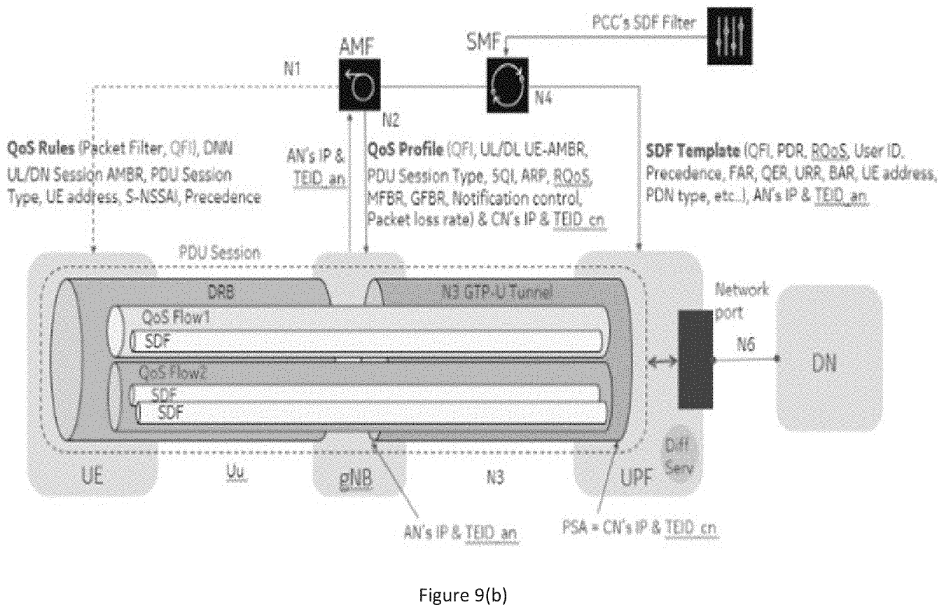

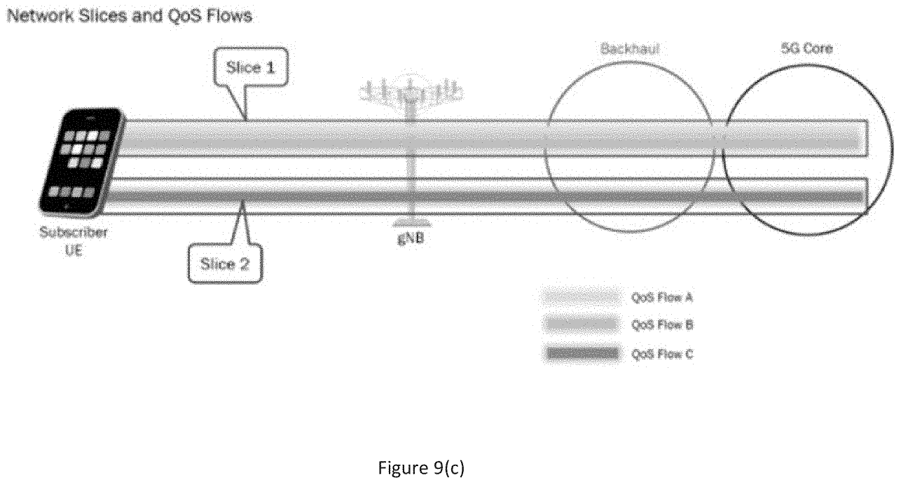

FIG. 9(a) is a table showing the 3GPP equivalent parameters that may be used to evaluate application performance over a specific network configuration. FIG. 9(b) is a table showing the 3GPP equivalent parameters that may be used to evaluate application performance across various network interfaces. FIG. 9(c) is a diagram illustrating the application performance over various network slice configurations for a specific network configuration. Thus, FIGS. 9(a)-(c) indicate the 3GPP specifications that allow an application to request a Quality of Service (QoS) from a network. This QoS requested by the application can be monitored by the network tools available in the back end of the platform. Applications can confirm the requested QoS is what the application stacks have been designed and coded to request and obtain.

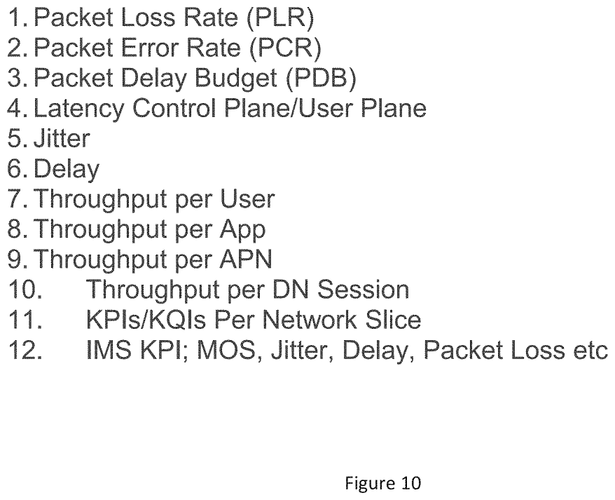

FIG. 10 is a diagram illustrating a list of Measured KPIs per QoS Flow and Network slice for an Application Performance Assessment, in accordance with some embodiments. FIG. 10 illustrates the vertical KPIs that an embodiment of the disclosed system/platform is able to extract and determine using a set of deep packet inspection network probes installed as part of the back end of the platform. These KPIs can be further checked or confirmed against the requested QoS illustrated with reference to FIGS. 9(a)-9(c) by the application under test.

These KPIs can help applications confirm that the network service level agreement (SLA) setup by requesting the QoS is able to be maintained by the network and the QoS is not deteriorated under ideal conditions of the network. Note that the QoS will deteriorate under non-ideal conditions of the network, such as when the network experiences higher traffic leading to congestion or when there is a failure in a network component causing network disruption.

The disclosed system/platform allows an application to test under non-ideal conditions to confirm how the QoS on the application behaves (such as by deteriorating) and recovers once the network recovers from congestion or disruption. These results are captured by the predictable performance assurance profile for testcases run under this category of performance assurance.

In an example use of the systems and methods described an application under test is recorded as its functionality is executed and an active co-relation to application performance over the network is provided. In one embodiment, a video in a frame is provided alongside the graphs generated from the testing process outputs. As a user moves a cursor across the graph, the video plays back to the same time as the specific time on the graph. Further, the test script log may be superimposed for a specific point on the graph. Graphs may be placed next to each other with a facility to mark a specific graph with the same marker showing up on other graphs for easier correlation.

In this sense, the testing and evaluation processes determine how a network characteristic might impact (or be impacted by) the use of a feature in an application (and in what way) so that measuring a network parameter and its changes during use of the application can provide an indication of how an application will perform or can be used with a given network configuration.

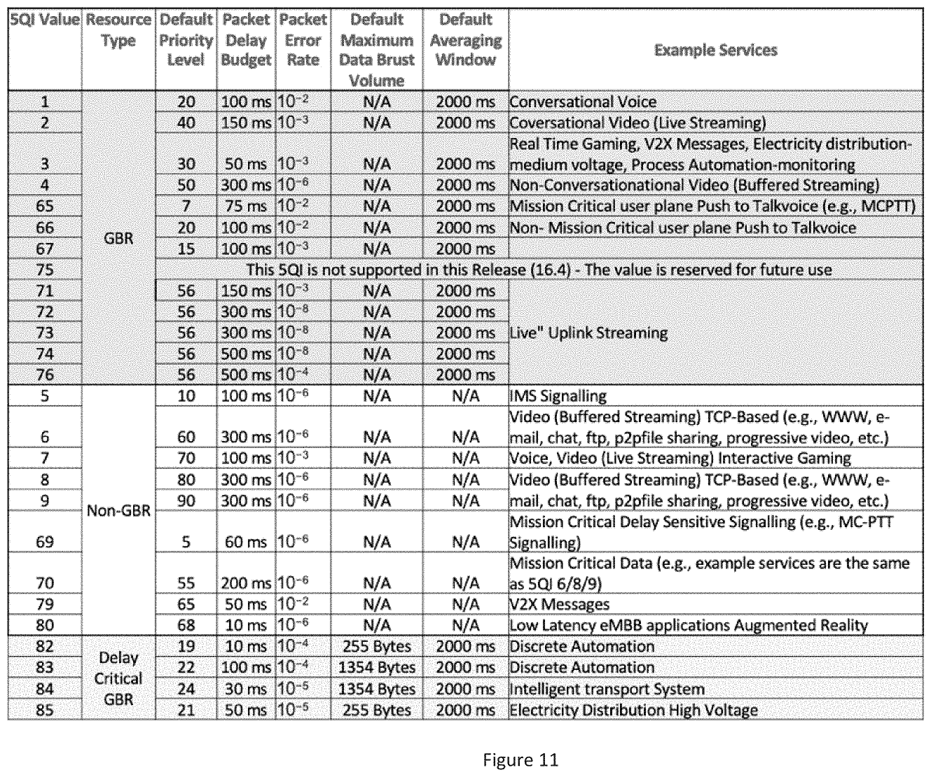

FIG. 11 is a table listing Recommended values for QoS Flow KPIs per bearer based on 3GPP standards, in accordance with some embodiments. The table illustrates established KPI values as specified by 3GPP standards for specific QoS requested by the application. The disclosed system/platform measures these KPIs while testing the application performance over the network and furnishes information to the application as to whether the correct KPIs are available for the QoS requested. Application developers can also confirm if the application performance observed is as expected per application design or if the application needs to request a different QoS for the desired performance of the application.

In some embodiments, network metrics are collected using a client embedded in a network with the ability to discover a network topology, decide where best to insert probes, activate the probes for deep packet inspection to acquire operational metrics in real-time and thereby to identify network performance during testing of an application.

Network topology discovery is a process that determines the interfaces on the network (for example, as illustrated in FIG. 1(a)). This may be accomplished by “pinging” a router connecting the interfaces. In some embodiments, the interfaces being discovered may include N1, N2, N3, and N6. Typically, these interfaces are connected over a router. The router ports and interface mapping to those ports are discovered and mirrored, and probes are installed on the router. At the time of testcase execution for a specific application under test, one or more probes are enabled, logs are captured, the logs are transferred to a time sensitive database and the probes are then disabled.

In some embodiments, the specific network metrics furnished for applications under test may comprise one or more of:
round trip time (latency);
throughput (bandwidth or speed) per application, per user per application;
energy and resource usage of the application under test on a given device in the network;
radio interface signal quality while an application is under test on a device connected over the air interface;
Packet loss rate;
Packet error rate;
Packet delay budget;
Content quality (resolution) if application is streaming content;
Jitter;
Delay;
QoS requested per application session; and
Network Slice KPIs.

The ability to capture KPIs and metrics of these types and at this level is not available on standard consumer networks (i.e., actual operating 5G networks available for use by consumers) for several reasons. To extract this information, consumer networks would need to support deep packet inspection capabilities and the return of the relevant parameters back to the user. This capability is not supported or provided by the widely available consumer networks. In addition, such networks typically do not provide the types (or classifications) of access desired by application developers to enable them to test their applications over a wide variety of the possible 5G scenarios. These scenarios may include testing an application under ideal conditions, testing the application while disrupting network connectivity and checking how the application recovers from it, and testing the application under congested network conditions.

The systems and methods described herein are motivated, at least in part, by a need for interested parties (e.g., application designers, developers, network administrators, network owners, service developers and application testers) to be able to test or evaluate the performance of an application in a realistic network configuration prior to launch and deployment of the application. With the advent of 5G networks, this is rarely possible and may result in a costly development and roll-out process, only to require later patches or modifications to an application. This is even more likely given the nature of 5G network variabilities, which may depend on the spectrum band the network is deployed on.

In contrast, previous 4G LTE networks only existed in low-band spectrum which resulted in a similar behavior from network to network. Moreover, most developers tested over Wi-Fi, which provided comparable results to those obtained over the actual network. However, given the Gbps data speeds and low latencies available in sub-mm wavelength bands over 5G networks, Wi-Fi does not provide the appropriate network characteristics to test high bandwidth, low latency, or machine-to-machine applications that require mobility management.

Embodiments provide a test or evaluation platform that can be used to simulate or emulate a network having a specific configuration so that the performance of both an application and network can be monitored during use of the application. This may result in changes to an application's feature set, to the implementation of a feature, to network management resource request rules for the application, or to another application or network related modification.

Embodiments enable an application developer to observe the impact of performing an activity over a 5G network, that is no longer considered a metered resource by a device (as some prior 4G and other networks may have been treated). These new networks allow or more effectively enable many desirable activities by an application, such as the pre-fetch of high bandwidth content without waiting to connect to a Wi-Fi network, activating or deactivating real time codecs to allow for higher quality content playback, and re-designing or de-activating compression algorithms which are not required over a high-speed network.

The benefits of 5G networks allow for different services and qualities of experience for users, performing activities that have not been tried previously over a regular Wi-Fi or LTE network due to a lack of sufficient network resources being available. Typically, these network resources are reduced or rationed across users to provide equal quality of service to all users on LTE and predecessor networks, for example by playing 4K or 8K content over the network that was only supported over optical broadband connections to a home. In contrast, and for the first time, 5G networks allow for service classification to different sets of users based on the quality of experience (QoE) they want to be provided with and are willing to be charged accordingly.

In some embodiments, the application testing system and methods described herein provide access to a private test network through a cloud-based server/platform that includes the ability to deploy deep packet inspection techniques to measure and evaluate the network interaction with an application.

Historically, the “best” application experience is usually available over Wi-Fi and most apps test over a local enterprise Wi-Fi. However, this type of testing does not assist in evaluating the ability to meet a guaranteed Service Level Agreement (SLA). With speeds up to 1 GBps available, meeting the terms of an SLA has not been a concern on Wi-Fi. Additionally, Wi-Fi is based on accessing a shared resource using contention-based protocols with collision detection CSMA-CD (Carrier Sense Multiple Access with Collision Detection) that allows for several devices accessing the medium and if there is a contention, the devices back off for an arbitrary amount of time to resolve the contention. Wireless networks do not employ similar contention-based protocols. Additionally, a problem with this form of testing is that Wi-Fi does not offer mobility management, which is highly desirable and almost required for much of the IoT applications and rich user experience applications of interest to users.

With the arrival of 5G networks, the best application experience will be available over a wireless network rather than an enterprise Wi-Fi network. This creates a strong motivation, and realistically a need, to be able to test an application over a network. Also, a network may provide a guaranteed SLA and allows the implementation of a Service Oriented Architecture (SOA) that exposes network APIs to allow an application to request network resources. Because of this capability, an application needs to understand how much to ask for and whether those grants of network resources help them to create differentiated service levels for their applications and users.

In one embodiment, a method for the testing and evaluation of an application's performance when the application is used with a specific network architecture and configuration may comprise the following steps, stages, operations, processes, or functions, as described in the following sections.

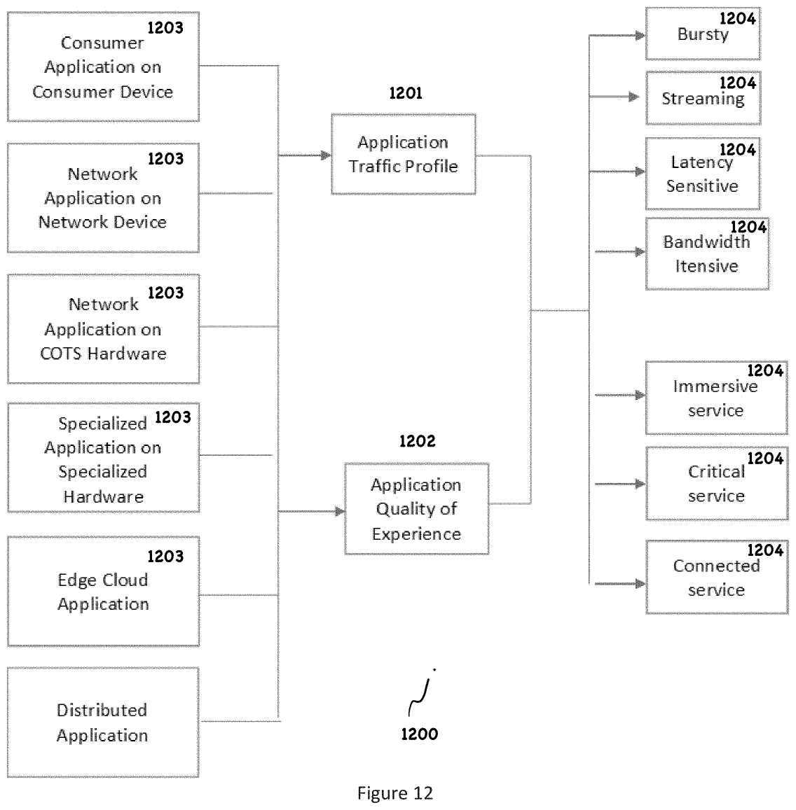

FIG. 12 is a diagram illustrating an example of an Application Profile Model (APM) Algorithm or Process Flow, in accordance with some embodiments. FIG. 12 illustrates an example of an Application Profile Model Algorithm designed for the front-end of the platform, which determines the application's integration profile into a network with a specific configuration. The Application profile helps select the testcase profile based on the Application traffic profile 1201 and Application Quality of Experience (QoE) 1202 as selected by the application developer or network administrator seeking to confirm the application performance or service performance over a network.

The Application Profile Model (APM) is used to develop or create a profile for an application to be tested/evaluated:
The profile may include data such as:
   Type of device and OS of device to be used for application installation and testing 1203;
   Nature of application data generation and interaction with edge or internet servers; and
   Nature of service provided by application as immersive vs. critical vs. latency sensitive (for example) 1204;
Define the network environment(s) (slices or sets of characteristics) the application will be evaluated with respect to—This may include characteristics such as:
   Bandwidth;
   Peak bandwidth;
   User experienced bandwidth;
   Round trip time;
   Energy consumption;
   CPU cycles;
   CPU tasks;
   RF conditions such as received power, received signal, signal to noise ratio and channel quality.

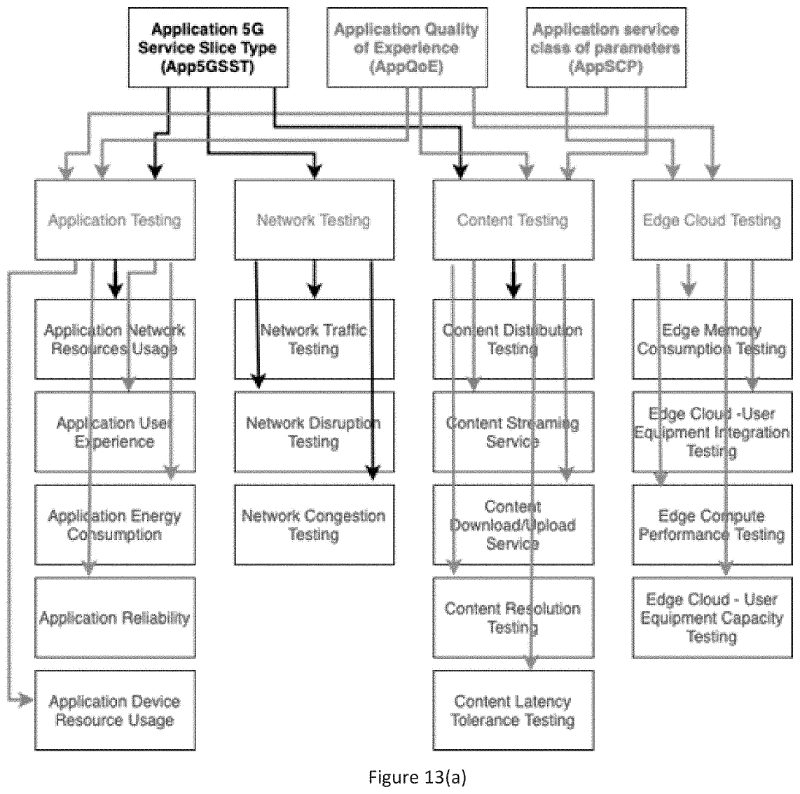

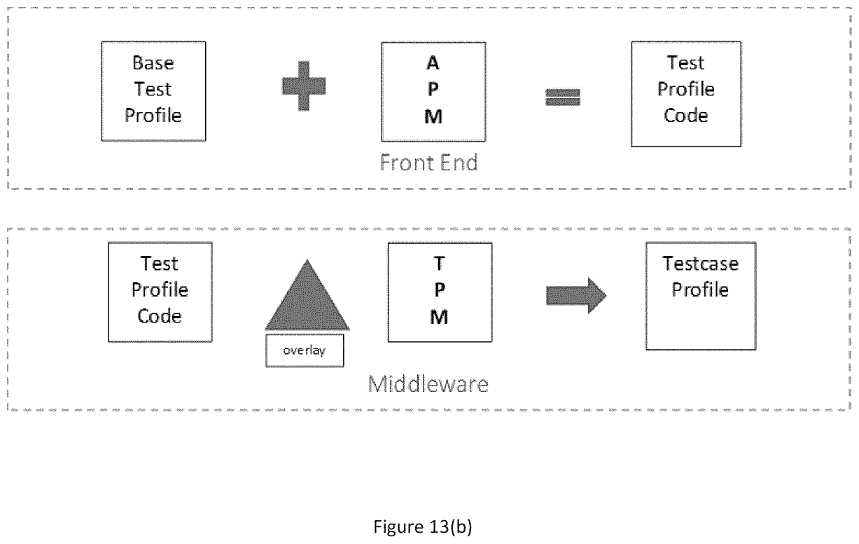

FIG. 13(a) is a diagram illustrating an example of a Testcase Profile Model (TPM) Algorithm or Process Flow, in accordance with some embodiments. FIG. 13(b) is a diagram illustrating an example of a Testcase Profile Generation Process, in accordance with some embodiments. The process flows shown in FIGS. 13(a) and 13(b) are examples of an algorithm that may be used to build the testcase profile from the application profile in the front-end platform. Based on this testcase profile provided by the front-end platform, the middleware auto-generates the testcases. This is done (at least in part) to abstract the network complexity and the knowledge required to build network testcases. With this methodology, application developers and network administrators do not need network development specific know how to be able to measure application performance over a given network configuration.

Based on the developed profile for the application and the defined network environment(s), generate a set of test cases for the application;
The test cases may be generated by a process that comprises:
   Evaluation of the application profile and understanding the location of application installation in the network;
   Determining whether high bandwidth content is transmitted and received by the application;
   Determining the nature of the content (i.e., whether it is AR, VR, 4K, 8K etc.);
   Determining whether the application availability and reliability are to be tested in conjunction with non-ideal (sub-optimal) conditions in the network;
   As a non-limiting example, a test case may be represented in the following format:
      Target KPI (mandatory)
         Physical Formula
         Unit
         Type of KPI (3GPP TS 28.554)
      Complementary measurements (optional)
         Secondary KPIs (optional)
         Co-relation between secondary KPI and Target KPI
      Pre-conditions (before executing a testcase sequence) (mandatory)
         Initial state of the system
         Equipment configuration
         Traffic description
      Test case sequence (mandatory)
         Set of processes needed for executing the experiment
      Methodology & Applicability (optional)
         Calculation process
         Expected output
         Application developer provides the list of features, capabilities, acceptable values, for variables via the Application Profile that affect the testing procedure
         Monitoring time
         Iterations required
         Monitoring frequency
         Measurement units (minx, max)
      Scenario Identification
      Configuration
         Network
         Network slice characteristics
         Network configuration parameters
         Transmission power in a base station
         Mobility of end device
         Network Status (Traffic load in the system)
         Service
         Environment
      Performance
         Quantify parameters that affect the values of the KPI
      Results Reporting
      Results processing
      Visualization
      Reporting.

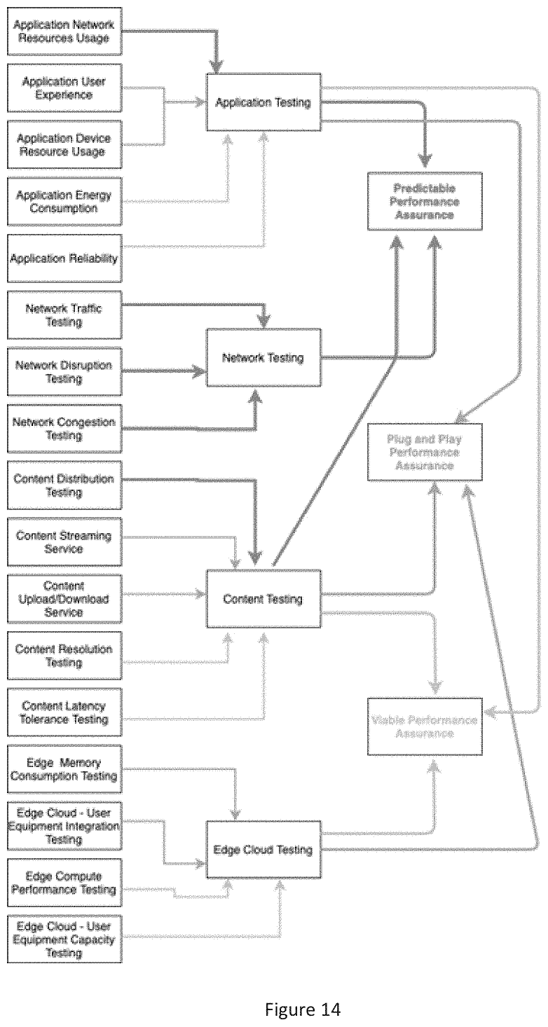

FIG. 14 is a diagram illustrating an example of a Performance Profile Generation Process, in accordance with some embodiments. FIG. 14 illustrates an example of an algorithm that may be used to generate a Performance profile for the application. In some embodiments, the performance profile is used to generate a dashboard having 3 distinct categories. The performance profile is determined from the testcase profile and application profile. In some embodiments, the 3 distinct categories are as described in the following sections.

Viable Performance Assurance

This performance measure provides a preliminary assessment of an application's performance on a network is based on a “standard” deployment (i.e., an initially assumed or default deployment or configuration) of 5G technology. This is the performance that an application expects from the network to meet throughput and latency requirements and is used to establish a standard Quality of Experience for the application. An example deployment may have the following parameters or metrics:
User Experienced Data Rate
Sustained User Data Rate
Peak User Data Rate
Capacity
E2E Latency
Mobility
Reliability
Availability

Plug and Play Performance Assurance

This performance measure corresponds to the performance that the application guarantees for smooth interoperability over a variety of networks worldwide. This is to establish the interoperable Quality of Experience for the application. Vertical represents an industry specific application and these measures refer to Layer 1 performance of the application (referring to layer 1 of the OSI layer diagram). These metrics may include: Application device CPU performance, Application device tasks, Application device battery consumption, and Radio connectivity (L1) to application device performance.

Predictable Performance Assurance

This deployment definition may be based on one or more 5G Service Slice Types¹, for example:
eMBB—Enhanced Mobile Broadband
URLLC—Ultra low Latency
mMTC—Massive Machine to machine communication
Reliability
Availability ¹ 5G network slicing is a network architecture that enables the multiplexing of virtualized and independent logical networks on the same physical network infrastructure. Each network slice is an isolated end-to-end network tailored to fulfill diverse requirements requested by a particular application. For this reason, this technology assumes a central role to support 5G mobile networks that are designed to efficiently embrace a plethora of services with very different service level requirements (SLR). The realization of this service-oriented view of the network leverages on the concepts of software-defined networking (SDN) and network function virtualization (NFV) that allow the implementation of flexible and scalable network slices on top of a common network infrastructure.

From a business model perspective, each network slice is administrated by a mobile virtual network operator (MVNO). The infrastructure provider (the owner of the telecommunication infrastructure) leases its physical resources to the MVNOs that share the underlying physical network. According to the availability of the assigned resources, a MVNO can autonomously deploy multiple network slices that are customized to the various applications provided to its own users.

This is an indication of the performance that the application needs to satisfy for a variety of network conditions (congestion, disruption) and network configurations (network slices). In one sense, this is to benchmark the minimum and maximum Quality of Experience and reliability for the application.

In some embodiments, Reliability is measured in terms of Continuity, Availability & Recoverability. Continuity primarily tests for application reliability for short duration network failures. Recoverability primarily tests for application reliability in terms of time to recover from failures. Availability primarily tests for application reliability in terms of recovery after multiple failures of different durations. The dashboards displayed and arrangement of testcases under those dashboards are determined from the performance profile. The performance profile also determines which KPIs and metrics are mapped to each dashboard.

For each executed test case in the set of test cases, collect information/data on the network and/or application performance during the execution of the test case. The collected information/data may comprise:
Radio Frequency measurements;
Security evaluation report;
Packet capture logs;
The information/data may be collected by a “probe” inserted into the network environment simulator/emulator.

Next, process the collected information/data to represent it in the form of a dashboard of metrics, graphs, and illustrations;
The dashboard may be accessed through a SaaS platform using an account on the platform that is associated with the developer or network administrator.

Further, in some embodiments, the system may generate a recommendation to an application developer or network administrator regarding a way to improve the performance of the application on the specific network environment.

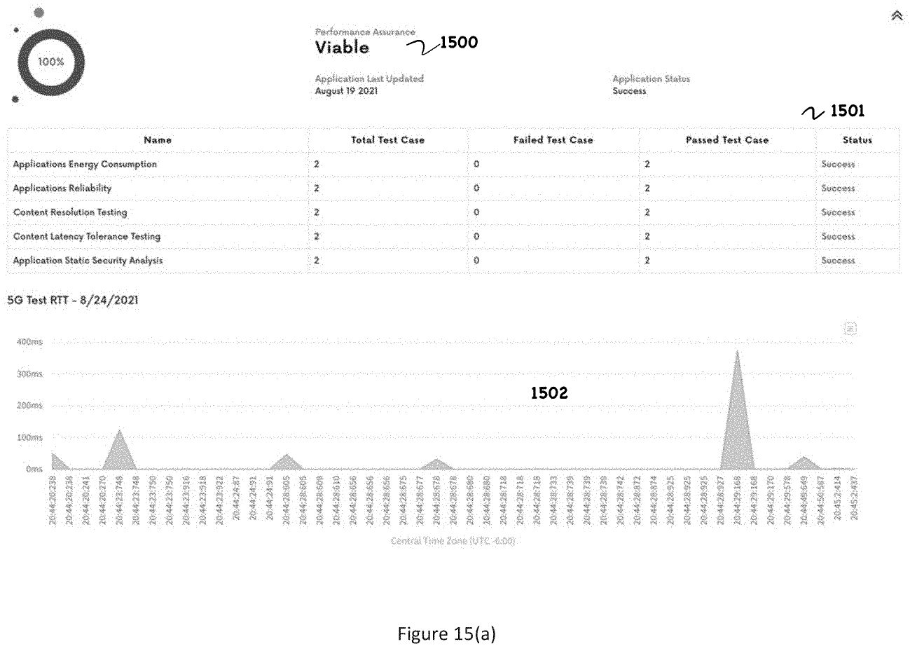

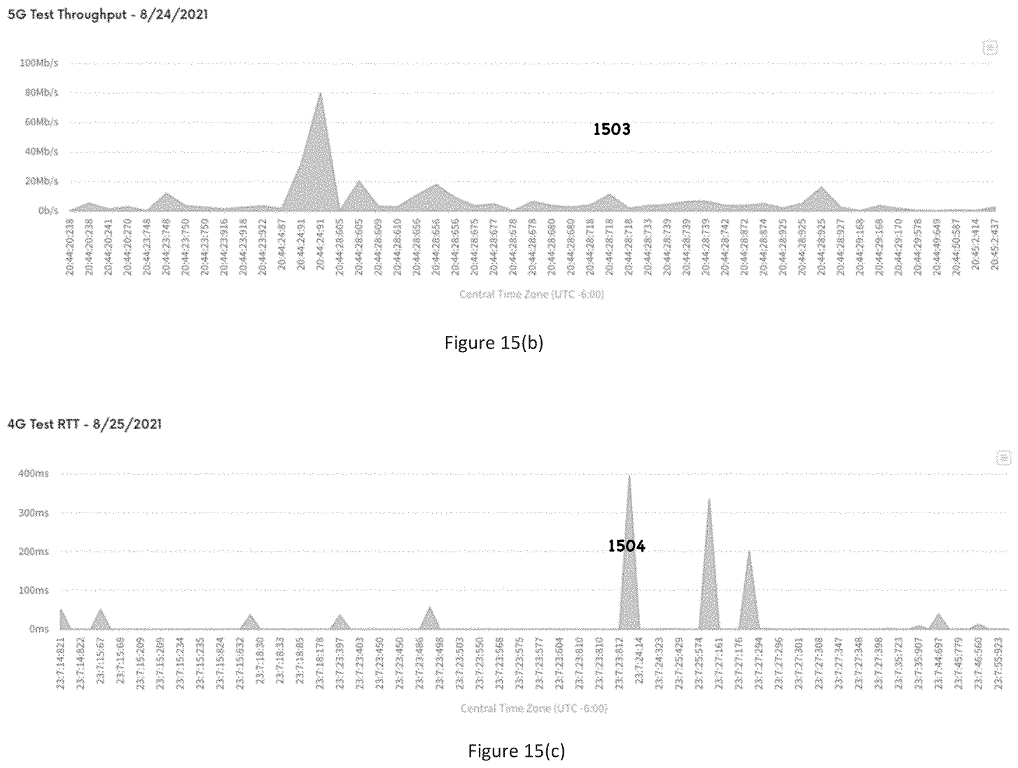

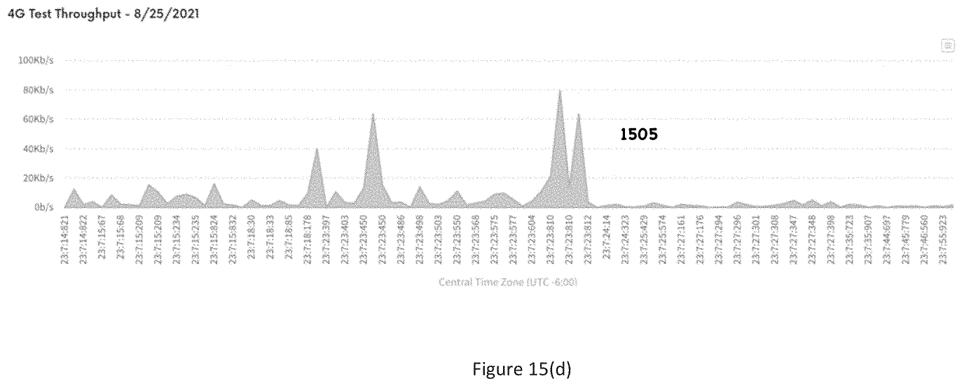

FIGS. 15(a) through 15(d) are diagrams illustrating examples of a Viable Performance Assurance Dashboard for an Application Performance Test, in accordance with some embodiments. These figures illustrate an example of a dashboard generated to show viable performance assurance 1500 for an application under test. The dashboard 1501 shows the % of successful testcases that were run to measure the KPIs provided under that category of performance tests. The dashboard table shows the number of testcases executed for each category of testcase selected by the testcase profile. It also shows the number of successful and failed testcases and an overall status for the testcase. In this example, 2 testcases were run. One was run for 5G network configuration and the second one was run for 4G network configuration.

In some embodiments, a part of the dashboard is a set of one or more visualization graphs 1503 for the network throughput measured while application under test is running over the network. Overlaid next to the graphs (not shown) is a video of the application executing so that network administrators and application developers can correlate the execution of the application with a specific action of the application produced the specific network effect as observed in the Network Throughput graph. A static analysis of the application code is also available to co-relate the specific line of code that may be under execution to produce the network effect depicted on the graph.

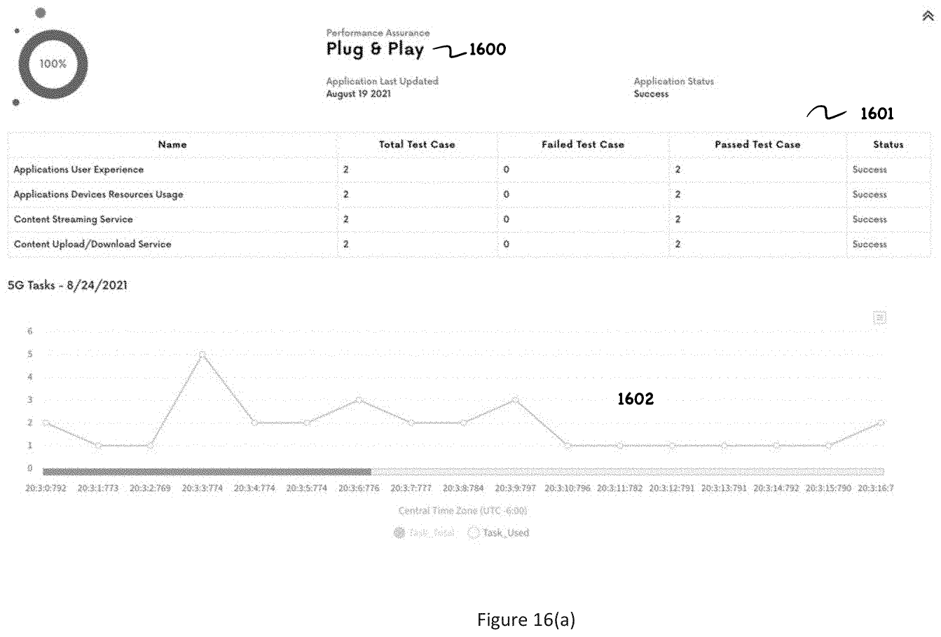

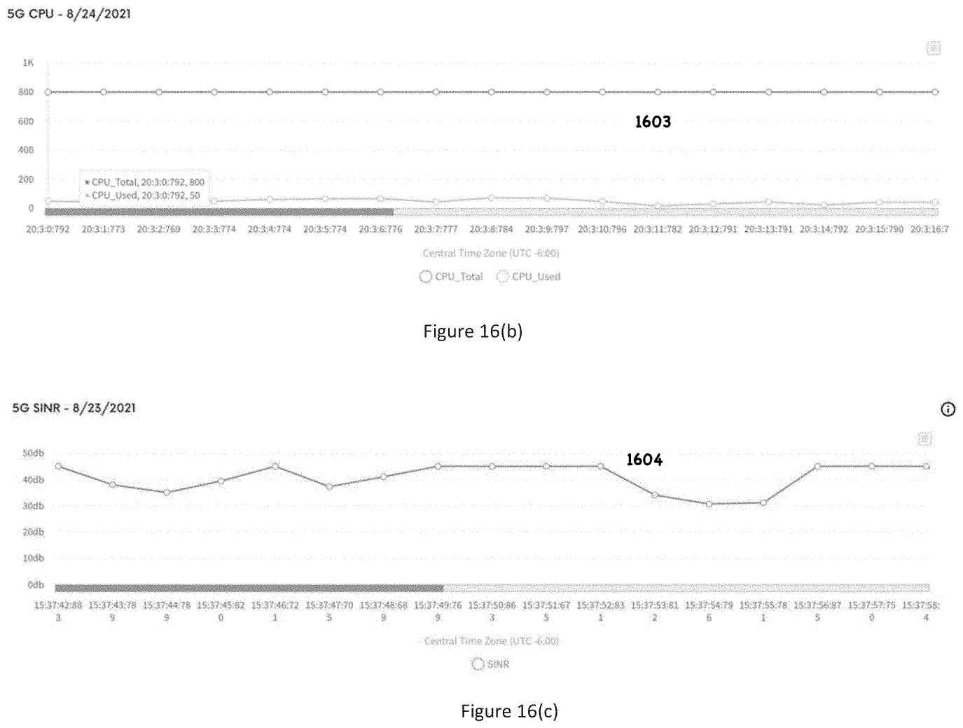

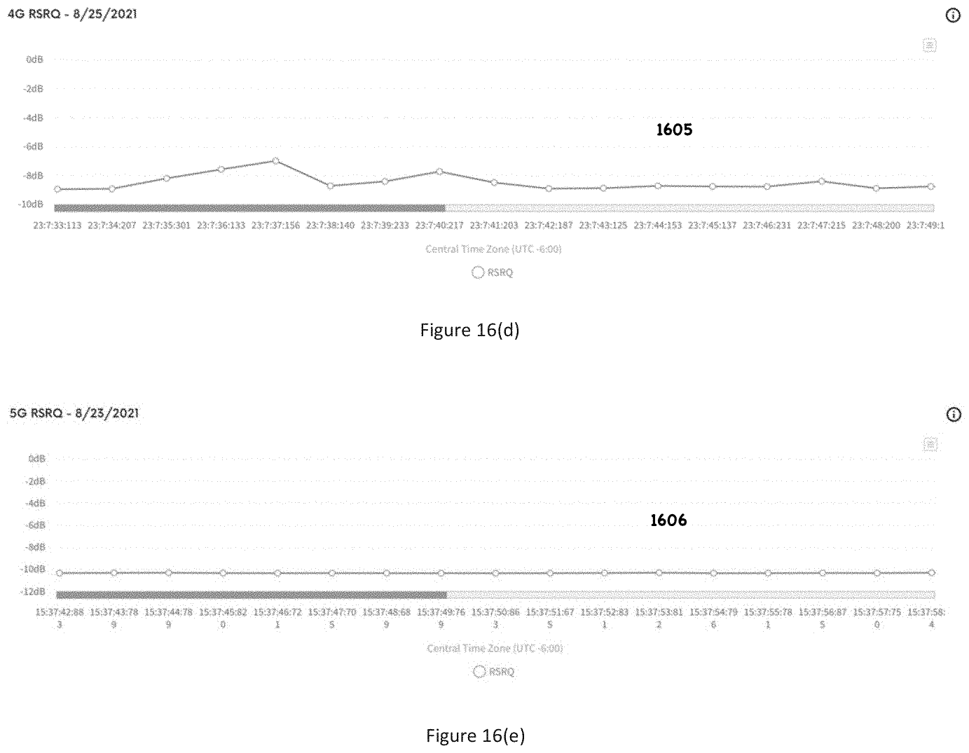

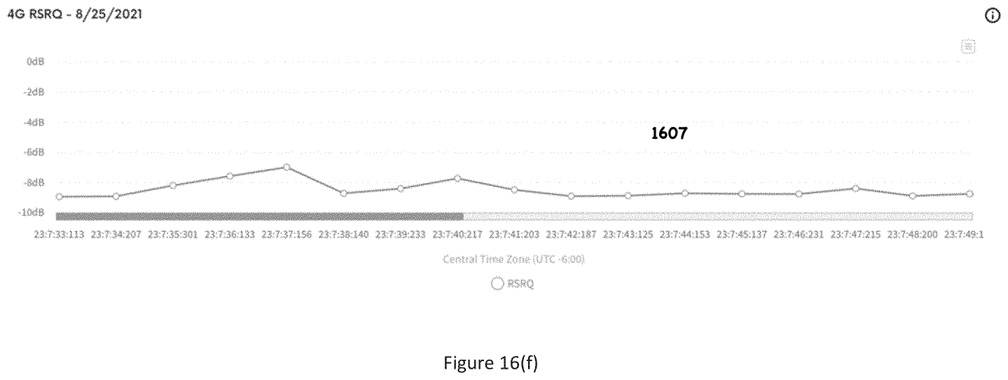

FIGS. 16(a) through 16(f) are diagrams illustrating examples of a Plug and Play Performance Assurance Dashboard 1600 generated for an Application under test, in accordance with some embodiments. These figures illustrate a sample dashboard generated to show plug and play performance assurance for an application under test. The dashboard 1601 shows the % of successful testcases that were run to measure the KPIs provided under that category of performance tests. The dashboard table shows the number of testcases executed for each category of testcase selected by the testcase profile. It also shows the number of successful and failed testcases and an overall status for the testcase. In this example, 2 testcases that were run. One was run for 5G network configuration and the second one was run for 4G network configuration.

In some embodiments, a part of the dashboard is a set of one or more visualization graphs for the application device performance measured while application under test is running on the device. The device could be a srnartphone, specialized hardware, COTS hardware, Edge Server. Overlaid next to the graphs (not shown) is a video run of the application so that network administrators and application developers can co-relate the execution of the application and which specific action of the application produced the specific device performance or network connectivity performance as observed in the application device task count 1602 or the application device CPU performance 1603. A static analysis of the application code is also available to co-relate the specific line of code that may be under execution to produce the device performance effect depicted on the graph.

This category of performance assurance depicts the plug and play performance of an application. In the sample application under test, the measurements captured are application device performance on which the application under test is executing. It also shows the radio connectivity performance using the radio parameters to confirm the quality of wireless signal over which the application is transmitted by the application device. These parameters namely RSRQ 1605 and 1606, RSRP, SINR 1604 and CQI indicate the quality of layer 1 (transmission medium) over which the application is interacting with the network. The quality of this medium is directly co-relational to the QoE and QoS of the application under test.

Note that the components and system elements described, which may be identified as Front End, Middleware, and Back End components and processes are typically implemented using one or more cloud infrastructures and dedicated physical servers on lab premises in one or more geographic locations. As such, in some embodiments, the system represents an example of a distributed service-oriented architecture (SOA) design.

Among other features or functions, embodiments of the systems and methods may provide one or more of the following services or features:
Application Performance Evaluation and Application Integration-as-a-Service providing Testing, Monitoring, Analytics and Diagnostics for one or more of an application developer, application user, or network operator;
   This type of testing service is useful in making decisions regarding application features, how best to implement a feature, expected costs to users, and expected impact on a network environment (i.e., a specific network configuration) during use;
   Embodiments provide a live network testing and evaluation platform that can be used to evaluate the performance of an application under a specific network configuration, so that the performance of both an application and the network can be monitored;
      This may cause a developer to modify an application feature set or the implementation of a feature;
      In some cases, this may lead to a change to the management rules the network applies to an application, the pricing models applied to end users, etc.;
Application Performance Evaluation and Integration procedures, tools, and methodologies to provide support to vertical use cases for 5G Networks;
   This refers to the general methods that have been described herein to generate testcases and collection of KPIs using DPI probes;
   Clearly defined Key Performance Indicators (KPIs) to support evaluation and validation of the interactions of an application under test with a specific 5G network configuration;
An application performance evaluation and integration framework developed using Virtualization, Network Slicing and Edge/Fog Computing;
   Currently available networks, such as 3G, 4G and even 5G Non-Stand-Alone (NSA) do not support Network Slicing or Edge/Fog Compute nodes. However, these are also features that applications need to interact with in the 5G Stand Alone (SA) Network. Network technologies such as 3G, 4G and LTE-A did not provide these features, and as a result, there was no application market developed for edge applications or native applications that interact with the network and request network slices; and
A standardized Evaluation and Integration Framework representing different levels of the 5G Network;
   In this regard, a Network Open System Interconnection (OSI) layer contains 7 layers—Physical, Data Link, Network, Transport, Session, Presentation and Application Layers. An application in an OSI model is the 7th layer. However, an application interacts through all 7 layers. Embodiments may extract/monitor the application interaction over a network through all levels of the network. This vertical extraction through all layers is displayed in various metrics and KPIs that are furnished to a developer or network administrator.

Conventionally, an obstacle to designing and implementing an effective application testing platform has been enabling the platform to accept a wide range of applications for evaluation. In this regard, conventional evaluation or testing services accept smart phone applications while the rest of the network is virtualized (i.e., it is a simulated network).

This limitation imposed by conventional approaches can reduce the value of a platform or system as applications can range from consumer-oriented applications executed on different consumer devices, to more specialized applications executing on specific hardware, and may include distributed applications accessed from a remote server. Further, in some cases, it may be desirable to test or evaluate content with regards to its ability to be transferred over a network and used by an application.

As suggested, locations for application installation have become more numerous because of the nature of 5G network architecture and a service-based network architecture. The disclosed platform and associated services are designed to permit evaluation and testing of many types of applications, which adds to the complexity of the platform design. Some of these complexities are addressed by creating application profiles for the various types of applications. Further, the live network used in embodiments of the systems and methods disclosed herein also provide access to edge compute servers to allow applications to install on the edge, as well as allowing applications to install in the network appliances.

The system and platform described herein overcome these limitations and provides an effective and scalable set of application testing and evaluation services. In some embodiments, the testing processes performed by the system and platform may include one or more of end user device or hardware testing, network testing, monitoring an application or applications as they interact with the network, usage of network bandwidth, round trip times for latency, and a measure of the overall end-to-end quality of a user's experience with the application.

In some embodiments, to accommodate a broad range of applications and content, the platform may perform one or more of the following functions, processes, or operations:
Develop a profile for an incoming application for use in testing and evaluation of the performance of the application with a specific network configuration;
Generate a set of testcases to execute as part of evaluating the performance of the application;
Recommend an initial system (with regards to an end user device and network) specification for application testing (i.e., a starting point);
Recommend the test parameters or measurements to be collected;
This refers to the application interaction with the network i.e., the application's consumption of the network resources (for example, network bandwidth consumption by application generated packets). Application generated packets could be application user data, application configuration data, streaming content, etc. Another example might be the number of application sessions established with the radio access network and the QoS flows requested for each application session; Map the test parameters or measurements to appropriate application performance metrics;
   Test measurements are mapped to application applicable parameters e.g., test measurements of time stamps for each packet sent and received translates to round trip time in the network and maps to application latency metrics;
   In some embodiments, artificial intelligence (AI) techniques and methods may be used to “learn” metrics across a wide variety of obfuscated application performance test runs. This approach may be used for benchmarking purposes. The benchmarked profiles of other obfuscated applications in a similar category can be provided alongside an application's own measurement, to show how other applications have performed on the network compared to the application being evaluated;
Plot (or otherwise visualize) the application performance metrics to provide meaningful visualizations to an application developer and/or network operator; and
Provide recommendations for application optimization or configuration to produce better performance of the application across one or more network configurations;
   As mentioned above, obfuscated application performance from similar category runs may be used to compare the performance of an application being evaluated to benchmarks or other standards. In some embodiments, machine learning (ML) and AI may be used for that purpose—in these embodiments, the platform learns over time an expected performance profile for a given application profile.
      In addition, in some embodiments, a static code stack is overlayed on the performance measurements to understand what the application software may have been executing when the time stamped published metrics were measured. This points directly to application design against its performance on the network (and may suggest modifications or improvements to algorithms, rules, and other aspects of how a function is executed).

As part of developing the described application testing services and features, a capability to autonomously perform application testing was developed. This capability includes several functions or features, including but not limited to:
Testing KPI definition, KPI sources, data and metric collection procedures and analysis;
   Testing frameworks (including requirements, environment, scenarios, expectations, limitations, or constraints) and tools. In some embodiments, the following types of tools were developed:
   Network Probes;
   KPI Recorders;
   Connectors;
   Metric Calculators; and
   Code Analyzers.

Network probes were developed for deep packet inspection and active raw data reading. Connectors continuously move read data from probes to a central database over a network bus. Recorders write moved data to a central time stamped database. Correlation and measurement tools termed metric calculators were written to perform active calculation on the recorded database values. Code analyzer tools were written for static code analysis against the time stamped database values;
Testing methodologies and procedures;
KPI validation methodologies;
Implementation of a testing lifecycle (i.e., testing execution, monitoring, evaluation, and reporting);
Software implemented network functions for simulation/emulation of application performance over a specific network configuration; and
Common information models for 5G T&M;
   Information model refers to a tool to assist in interpreting the differences in 5G KPIs as defined by 3GPP. To establish a comparative run between 4G and 5G network testing, a common mapping was desirable and needed to be developed. This mapping is referred to as an information model herein;
      For example, a common parameter name is chosen called QoS Identifier. In 5G, it is referred to as 5G QI (QoS Identifier) and in 4G it is referred to as QCI (QoS Class Identifier). Similarly, to determine IP Data Flow, the platform measures a QoS parameter in 5G, while in 4G it examines the EPC Bearer. To query the data session, in 5G the platform queries PDU session, while in 4G it queries PDN connection.

In some embodiments, the application testing and evaluation approach described herein and implemented by the system or platform includes monitoring both network and application performance. This monitoring may be a process that generates or acquires metrics for various components/layers of a 5G network. The application monitoring metrics may be collected as part of an application profile. In some cases, an application developer may provide an approximate application profile to the testing and evaluation system. The system monitors the application profile metrics and additional aspects of the network and application performance. This provides an opportunity for an application designer to obtain a more complete understanding of an application's behavior and usage of network resources under a variety of conditions.

The wireless technologies and networks, including network equipment, follow Industry standards developed by International Telecommunication Union (ITU), European Telecommunication Standards Institute (ETSI) and 3rd Generation Partnership Program (3GPP). Although testing of network equipment and technologies has been standardized using recommendations published by these bodies, testing of applications has conventionally been an ad-hoc endeavor lacking structure or formal requirements.

To allow for the test platform to adapt to the changing needs of technology and standards development, the test cases allow for modular inclusion of new recommendations received from standards bodies and organizations. As an example, as new KPIs and further adaptation to more advanced technologies in the future (e.g., 6G) occur, these can be incorporated by adding test components specific to 6G standards in a modular fashion, while continuing to utilize the base process automation architecture to construct testcases using modular testing components.

A design goal of the disclosed test system architecture is to modularize the construction of its front-end, middleware, and back-end components and processes. This allows those components and processes to be implemented as micro-services and enables them to adapt and change, while maintaining the user (for example, an application developer, network operator, or network administrator) experience of interacting with the platform. Specifically, the platform defines testing categories which are network centric but are network technology agnostic. The testing categories are defined and automatically selected with reference to the type of application being tested. This approach is important to provide a standardized benchmarking for all applications irrespective of the type of network or network configuration they are being tested on.

In some embodiments, each Network slice may be associated with a specific service level requirement (SLR). For example:
eMBB SLR (Service Level Requirement)
   high bandwidth >=10 Gbps and high throughput of the network >10 Gbps with high data rates >10 Gbps
URLLC
   latency <=1 ms
mMTC
   battery life=10 years, throughput=160 bits per second, coverage density of million devices in a square mile, round-trip latencies <10 seconds
      In some embodiments, the application testing is performed to measure a network slice SLR conformance to application under test measurements of bandwidth, throughput, latency, battery consumption and coverage density.

Data generated by the execution of relevant test cases, subject to an architecture deployment (cloud core implementation vs. on premise core implementation) and service slice type, are gathered, analyzed, and summarized for users of each vertical (where vertical is typically an industry specific application). This helps to characterize the behavior of a 5G-compatible application and end-user device, under a variety of internal and external operating conditions.

The platform and functionality described herein reduce the effort required for testing 5G infrastructure and components and evaluating the performance of an application. By simplifying the testing operations and providing a Continuous Integration (CI) pipeline as a built-in function, the platform can ensure a stable performance.

For example, a network administrator can use the platform to bring new applications into production networks and/or update existing applications with recurring releases, thus providing a continuous integration functionality for the production network with continuous updates from applications developers. Similarly, an application developer can test and certify the application on a test network through the platform and then network administrators can bring in the application and test its performance on a specific production network.

The platform serves as an automation platform for validating and verifying the entire 5G system, from the individual components to the E2E service. This is accomplished, at least in part, by the ability to abstract the complexity involved in testing the various layers ranging from Conformance to Security and from Performance to QoE.

In some embodiments, the platform includes test and measurement tools useful for validating and verifying 5G systems. These tools are used for both standard network test cases as well as custom test cases for vertical application testing. As other types of tests are developed, they can be made available through the platform.

In some embodiments, the available tools or testing functionality may include, but are not limited to or required to include:
1. L2-L3 Traffic generators to test performance of the transport layer;
2. L4-L7 Traffic generators to test across the network function layer, and to test a vertical application;
3. Emulators to emulate vertical E2E application;
4. 5G Traffic generators;
5. Conformance Tools; and
6. App Emulators provided by application developers.

In some embodiments, the systems and methods described herein include or implement one or more of the following decision processes, routines, functions, operations, or data processing workflows for the indicative platform function or feature:
1. An adaptive input criterion for each application provided for testing and evaluation:
   a. The adaptive aspect is based on the inputs provided. Based on the initial input, a set of questions are asked. For example, selecting application type as consumer, will set the next question to be on the specific consumer type hardware. Based on the selected hardware type, the specific Operating System types will be displayed by the platform as Operating Systems available on that commercially available consumer hardware etc.;
2. Input data is gathered or accessed that characterizes the application and generates an Application Profile. In some embodiments, the data used to build the Application Profile includes:
   a. Application Type—Consumer Application on Consumer Device, Network Application on Network Device, Network Application on COTS Hardware, Specialized Application on Specialized Hardware, Edge Cloud Application, or Distributed Application;
   b. Hardware Type—Smart phone, General Purpose CPU, GPU, Specialized CPU, SoC, Controller, Cloud Provider VM, Server, Raspberry Pi, Arduino etc.;
   c. Service Slice Type—Enhanced Mobile Broadband, Ultra low Latency, Massive Machine to machine communication or a combination of these; and
   d. Content Streaming and Type—4k, 8K, VR, AR etc.;
3. The Application Profile is passed through an un-supervised learning algorithm trained with data from previous applications under test (AUT) to (in some cases) generate a more accurate model for the Application Profile;
   a. Initial training data is constructed from sample application profiles and overlaid with network configuration and performance analysis gathered from sample test runs. Once a customer provides a profile for an application uploaded, the training data is used to extract more precise specs for the application, such as application data rates, round trip times, number of connections etc. The training data becomes more robust as it learns from applications that have been tested;
   b. The application profile asks developers to provide application service class parameter values. Sometimes, application developers do not know these values and provide default values (already provided) in the profile or the values provided may be a guestimate. In some embodiments, the platform may use historical data to replace these values and provide more precise thresholds for measurement analysis in the network;
4. Platform uses the optimized Application Profile model to auto-generate a Testcase Profile using a supervised learning algorithm;
   a. In some embodiments, the learning algorithm is a decision tree algorithm. It follows the application model settings to arrive at a testcase model. The decision tree has value nodes for each parameter that comprises an application model. Based on the values for each application model parameter, a testcase profile is reached at the end of a branch.
5. The auto-generated Testcase Profile is encoded and passed to a testcase generator:
   a. The testcase profile is encoded to minimize the amount of information that to be passed to the next layer. The next layer can be a Virtual machine in the cloud or a Server on premises. The encoding will typically contain information about the testcase model—initial network configuration and specifications, test categories, and specific testing needs for an application;
6. Testcases are auto-generated by the platform based on the encoded testcase profile:
   a. To make a testcase, various components are gathered. In some embodiments, there are pre-made components available in a component library separated into categories. An RPA process may be used to gather the various components based on the test code received that will enable a testcase to be constructed;
7. A test lab orchestrator finds a match for an optimized network test bed based on the initial starting point of the system:
   a. In some embodiments, the first parameter that is considered is Network Type, whether it is 4G or 5G Network. The next parameter is the Network Slice Type. The platform virtualizes the Network and the Network slices. Based on the Network Slice Type chosen for the application, a physical network offering the specific Network Service and specific to the Network Slice Type is chosen. In some embodiments, the physical test beds may be optimized for specialized use cases, such as autonomous driving with an autonomous vehicle and driving track, tele-health with hospital grade equipment connected to the network, sports equipment including myriad video cameras to emulate a sports arena, precision agriculture, etc. These are specialized networks offering not only these use cases as network slices but providing the end user equipment that can test stand-alone or distributed applications requiring UE-Edge Cloud interaction. The Application Service Slice Type from the Application Profile and Network Type encoded in the Test case Profile is used to determine the match with a physical network test bed;
8. Testcase orchestrator organizes the testcases for the lab end point and enables Robotic Process Automation (RPA) to execute the testcases:
   a. As described, the platform operates to build testcases using components that together can be used to generate a desired test case. The testcase build is automated, as is the testcase execution;
9. Test logs are collected during the test case execution;
10. The test logs are parsed to extract the testcase results. The testcase results are returned to the platform as a Result Profile;
   a. The testcase results auto-generate a Performance profile for the AUT. The data is visualized as a radar graph (spider graph) comparing 4G or 5G network capabilities, to the application requirements.
      The measured results are Application Service Class Parameters which quantify application performance. The results help the application developer to better understand:
         i. If the application is truly utilizing the network's capability;
         ii. Whether the application can be run on other networks or different slices with lower capabilities; and
         iii. The right (most optimal) network slice type that the application should subscribe to;
11. The platform maps the testcase results to the Performance Profile;
12. Both Testcase Results Profile and the Performance Profile are published back to the entity performing the AUT;
13. Testcase execution is updated periodically to provide testcase velocity and testcase execution progress;
   a. Testcases are run when the network resources can be reserved end-to-end. For example, all testcases on a 5G network may be executed because the network is available and reservable. However, if a comparison test is to be run on a 4G network, it is possible that the 4G network is not available at the same time. In this event, the testing may return the 5G status but may still be waiting on 4G network reservation. Providing periodic updates, informs the user which testcases are completed and which are outstanding pending resource reservation in the network;
14. The Performance Profile is converted to a Performance Visualizer for the application developer to enable them to better understand the results of the application test:
   a. in relation to the network capabilities, both 4G & 5G; and
   b. In relation to the anonymized performance of similar applications.

For Application Developers, providing early-stage testing of their use cases over a standards-based full-chain 5G system or emulation, and following a systematic approach, enables a range of vertical industries to make timely and well-informed business decisions regarding launching their services and offering guaranteed service performance levels. This will ensure greater end user satisfaction and fewer network associated problems, and therefore a higher likelihood of business success.

The systems and methods described provide End-to-End (E2E), NFV characterizations, along with performance evaluation in a 5G heterogeneous infrastructure (including generalized Virtualization, Network Slicing and Edge/Fog Computing). The systems and methods include Test and Measurements (T&M) procedures, tools, and methodologies (i.e., testing, monitoring, analytics, and diagnostics) to ensure a robust, carrier-grade geographically diverse 5G Test Infrastructure.

Considering a vertical innovation lifecycle, verticals planning to leverage 5G as a key enabler in their development process are expected to face the challenge of developing and validating new solutions. These may include:

1. Verticals addressing a basic business need for their operations and/or customers which is dependent on and sensitive to the underlying communications network's performance, can utilize the systems and methods described to test and evaluate their applications and assumptions prior to roll-out in a network. The expectations on their applications for meeting extreme network reliability, sustained high throughput levels, or close to real-time communication services (to mention examples of potential requirements) need to be carefully assessed versus the 5G technology performance benchmarks to provide a viable/reasonably achievable assurance of performance;

2. 5G applications should behave properly within their specific and expected performance levels, and according to prediction models, thus confirming that well-defined objectives of an SLA are attainable and “guaranteed” by the underlying 5G network, and are satisfied for a variety of application scenarios and 5G network configurations and conditions (to generate a measure of the predictable performance of an application under realistic network operating conditions); and

3. Customers (developers) that expect to scale and reach a global market expect smooth interoperability and guaranteed performance levels with a variety of commercial 5G networks worldwide that their applications will be deployed upon (sometimes referred to as plug-and-play performance assurance).

The concurrence and convergence of fast-paced innovation at a variety of verticals with the development and roll-out of 5G by the global communications ecosystem brings new opportunities, but also poses additional risks and challenges, especially for pioneering initiatives. 5G literature lists 5G KPIs as associated with values for maximum theoretically achievable performance. However, there are several 5G Service Slice Types, such as eMBB, URLLC, and mMTC, that may condition or modify a specific set of 5G KPIs associated with an application.

Unfortunately, a commercially deployed 5G network is not the type best suited to providing an environment that verticals can utilize for completing the various stages of application development and testing. In most cases, the insights regarding application behavior and performance needed by a vertical to complete their innovation cycle can best be provided by an experimentation facility that provides them with the tools and processes to carry out testing and measurement activities, and to explore the impact of variations in application parameters, network operating parameters, and KPIs on application behavior and the experience of end users.

The systems and methods described provide access to this type of experimental network lab through a platform. Further, for understanding the desired Quality of Service/Experience (QoS/QoE) for an application over a 5G network, it is important to understand a developer's needs and network connectivity expectations, and to translate them into suitable network configurations and the selection of appropriate technological features. The use of the described systems and methods can provide guidance or recommendations for the provisioning of an optimum 5G slice selection of suitable SW and HW components in the Core, Transport and Radio network per vertical industry, with guaranteed performance metrics. This will result in better application behavior and end user satisfaction.

As an example of how the test results may be used:
Testcase monitoring results are published as a first level. These are testcases updated with an overall status of PASS and FAIL;
   Both PASS & FAIL testcases are updated with captured logs and measured metrics.
      In the case of the FAIL testcases, application developers can utilize the logs and metrics to troubleshoot further. Network anomalies causing testcases to fail are kept at a minimum. Network is guaranteed to be functioning at its optimal level with the help of sanity checks and automated testing to confirm the sanctity of the network and to confirm the required initial state of the network as per the testcase initial state parameter as required by the application.
For the testcases that PASS, the recommendations can be classified into:
   4G or 5G related benchmarking i.e., Technology benchmarking; and
   Application benchmarking.
Technology benchmarking
   These testcase results characterize the architecture, stack, or application in relation to the network parameters. The network KPI of interest here is primarily throughput, delay, Uplink (UL) and Downlink (DL) latency. By providing the ability to test the applications on both 4G and 5G, the benchmarking can highlight the inadequacies of a given network in supporting the application requirements.
Application benchmarking
   These testcase results characterize the application behavior over the network. The characterization can be done with network variables such as traffic, congestion, delay etc. Latency variation and delays observed in stack operations of an application itself, e.g., buffering delays.

This benchmarking is further analyzed against the specific 5G network slice type. Applications can be tested for specific network slice type or can be tested for all network slice types:
Enhanced Mobile Broadband (eMBB)—which needs to support large payloads and high bandwidth;
Massive Machine Type Communications (mMTC)—which needs to support huge number of devices connected to the network; and
Ultra-Reliable Low Latency Communications (URLLC)—which needs to support use cases with a very low latency for services that will require extremely short response times.
   From these results, in some embodiments, one or more of the following may be determined:
1. Whether a planned application service can be provided by existing 4G networks;
2. Even as new 5G networks are launched with limited network parameters, can the commercial launch of the service be supported with lower metrics such as availability, reliability etc.;
3. How robust is a transmission of mission critical data if the application service belongs to that category?
4. What is the peak demand for an application over a network? Peak demand is defined as usage under certain high usage circumstances but not constantly;
5. Whether an application targeted for a specific network slice is an ideal candidate for that network slice; and
6. Application designers can understand whether the latency experienced on the network is suitable for the application or requires an innovative approach on their end to adapt to the latency observed.

The disclosure includes the following clauses and embodiments:

1. A method for evaluating the performance of an application when used with a network configuration, comprising:

obtaining data characterizing an application to be evaluated;

generating one or more test cases for the application based on the data characterizing the application;

determining a network configuration for each test case;

executing each test case in a live network having the specified network configuration;

obtaining data from the execution of the test case using a deep packet inspection probe inserted into the live network;

correlating the obtained data from the execution of the test case to a performance profile for the application; and

providing the performance profile to a developer of the application.

2. The method of clause 1, wherein the data characterizing the application to be evaluated further comprises one or more of a device type, an operating system for the device, a requested network slice type, and whether the application is expected to be bursty, continuous, bandwidth intensive, or latency sensitive with regards to network usage.

3. The method of clause 1, further comprising generating a test case profile from the data characterizing the application, and the test case profile is generated using a trained model.

4. The method of clause 1, wherein determining a network configuration for each test case further comprises determining one or more of bandwidth, network protocol, frequency band, and network slice for the test case.

5. The method of clause 1, wherein the live network comprises user equipment, a radio, routing equipment, and one or both of a 5G and 4G core service.

6. The method of clause 1, wherein the deep packet inspection probe is a plurality of such probes, with each probe inserted at an interface in the live network.

7. The method of clause 1, wherein the performance profile provided to the developer is a graph or table illustrating a consumption of a network resource by the application during the test case.

8. The method of clause 7, wherein the performance profile is generated under one of a set of possible operating conditions.

9. A system for evaluating the performance of an application when used with a network configuration, comprising:

one or more electronic processors configured to execute a set of computer-executable instructions; and

the set of computer-executable instructions, wherein when executed, the instructions cause the one or more electronic processors to
obtain data characterizing an application to be evaluated;
generate one or more test cases for the application based on the data characterizing the application;
determine a network configuration for each test case;
execute each test case in a live network having the specified network configuration;
obtain data from the execution of the test case using a deep packet inspection probe inserted into the live network;
correlate the obtained data from the execution of the test case to a performance profile for the application; and
provide the performance profile to a developer of the application.

10. The system of clause 9, wherein the data characterizing the application to be evaluated further comprises one or more of a device type, an operating system for the device, a requested network slice type, and whether the application is expected to be bursty, continuous, bandwidth intensive, or latency sensitive with regards to network usage.

11. The system of clause 9, wherein the instructions further cause the one or more electronic processors to generate a test case profile from the data characterizing the application, and the test case profile is generated using a trained model.

12. The system of clause 9, wherein determining a network configuration for each test case further comprises determining one or more of bandwidth, network protocol, frequency band, and network slice for the test case.

13. The system of clause 9, wherein the live network comprises user equipment, a radio, routing equipment, and one or both of a 5G and 4G core service.

14. The system of clause 9, wherein the deep packet inspection probe is a plurality of such probes, with each probe inserted at an interface in the live network.

15. The system of clause 9, wherein the performance profile provided to the developer is a graph or table illustrating a consumption of a network resource by the application during the test case.

16. A set of computer-executable instructions that when executed by one or more programmed electronic processors, cause the processors to evaluate the performance of an application when used with a network configuration by:

obtaining data characterizing an application to be evaluated;

generating one or more test cases for the application based on the data characterizing the application;

determining a network configuration for each test case;

executing each test case in a live network having the specified network configuration;

obtaining data from the execution of the test case using a deep packet inspection probe inserted into the live network;

correlating the obtained data from the execution of the test case to a performance profile for the application; and

providing the performance profile to a developer of the application.

17. The set of computer-executable instructions of clause 16, wherein the data characterizing the application to be evaluated further comprises one or more of a device type, an operating system for the device, a requested network slice type, and whether the application is expected to be bursty, continuous, bandwidth intensive, or latency sensitive with regards to network usage.

18. The set of computer-executable instructions of clause 16, wherein the instructions further cause the one or more electronic processors to generate a test case profile from the data characterizing the application, and the test case profile is generated using a trained model.

19. The set of computer-executable instructions of clause 16, wherein determining a network configuration for each test case further comprises determining one or more of bandwidth, network protocol, frequency band, and network slice for the test case.

20. The set of computer-executable instructions of clause 16, wherein the live network comprises user equipment, a radio, routing equipment, and one or both of a 5G and 4G core service, the deep packet inspection probe is a plurality of such probes, with each probe inserted at an interface in the live network, and the performance profile provided to the developer is a graph or table illustrating a consumption of a network resource by the application during the test case.

21. A system for evaluating the performance of an application when used with a network configuration, comprising:

a live telecommunications network;

a set of deep packet inspection probes installed at a plurality of interfaces of the live network;

a test generator operative to generate one or more test cases for the application based on data characterizing the application;

a network configuration element operative to configure the live network in a specific network configuration for testing the application;

a test case execution element operative to execute at least one of the generated test cases in the live network, where the network is configured in accordance with the specific network configuration;

a data collection element operative to collect data from the set of deep packet inspection probes;

a process to associate the collected data with performance of the application during execution of the test case; and

a process to generate one or more displays of the performance of the application during execution of the test case.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

In some embodiments, certain of the methods, models or functions described herein may be embodied in the form of a trained neural network or machine learning model, where the network or model is implemented by the execution of a set of computer-executable instructions. The instructions may be stored in (or on) a non-transitory computer-readable medium and executed by a programmed processor or processing element. The specific form of the method, model or function may be used to define one or more of the operations, functions, processes, or methods used in the development or operation of a neural network, the application of a machine learning technique or techniques, or the development or implementation of an appropriate decision process. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

When implemented as a neural network, a machine learning model is a set of layers of connected neurons that operate to make a decision (such as a classification) regarding a sample of input data. A model is typically trained by inputting multiple examples of input data and an associated correct “response” or decision regarding each set of input data. Thus, each input data example is associated with a label or other indicator of the correct response that a properly trained model should generate. The examples and labels are input to the model for purposes of training the model. When trained (i.e., the weights connecting neurons have converged and become stable or within an acceptable amount of variation), the model will operate to respond to an input sample of data to generate a correct response or decision.

Any of the software components, processes or functions described in this application may be implemented as software code to be executed by a processor using any suitable computer language such as Python, Java, JavaScript, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method for evaluating the performance of an application when used with a network configuration, comprising:
obtaining data characterizing an application to be evaluated;
generating one or more test cases for the application based on the data characterizing the application;
determining a network configuration for each test case;
executing each test case in a live network having the specified network configuration;
obtaining data from the execution of the test case using a deep packet inspection probe inserted into the live network;
correlating the obtained data from the execution of the test case to a performance profile for the application; and
providing the performance profile to a developer of the application.

2. The method of claim 1, wherein the data characterizing the application to be evaluated further comprises one or more of a device type, an operating system for the device, a requested network slice type, and whether the application is expected to be bursty, continuous, bandwidth intensive, or latency sensitive with regards to network usage.

3. The method of claim 1, further comprising generating a test case profile from the data characterizing the application, and the test case profile is generated using a trained model.

4. The method of claim 1, wherein determining a network configuration for each test case further comprises determining one or more of bandwidth, network protocol, frequency band, and network slice for the test case.

5. The method of claim 1, wherein the live network comprises user equipment, a radio, routing equipment, and one or both of a 5G and 4G core service.

6. The method of claim 1, wherein the deep packet inspection probe is a plurality of such probes, with each probe inserted at an interface in the live network.

7. The method of claim 1, wherein the performance profile provided to the developer is a graph or table illustrating a consumption of a network resource by the application during the test case.

8. The method of claim 7, wherein the performance profile is generated under one of a set of possible operating conditions.

9. A system for evaluating the performance of an application when used with a network configuration, comprising:
one or more electronic processors configured to execute a set of computer-executable instructions; and
the set of computer-executable instructions, wherein when executed, the instructions cause the one or more electronic processors to
obtain data characterizing an application to be evaluated;
generate one or more test cases for the application based on the data characterizing the application;
determine a network configuration for each test case;
execute each test case in a live network having the specified network configuration;
obtain data from the execution of the test case using a deep packet inspection probe inserted into the live network;
correlate the obtained data from the execution of the test case to a performance profile for the application; and
provide the performance profile to a developer of the application.

10. The system of claim 9, wherein the data characterizing the application to be evaluated further comprises one or more of a device type, an operating system for the device, a requested network slice type, and whether the application is expected to be bursty, continuous, bandwidth intensive, or latency sensitive with regards to network usage.

11. The system of claim 9, wherein the instructions further cause the one or more electronic processors to generate a test case profile from the data characterizing the application, and the test case profile is generated using a trained model.

12. The system of claim 9, wherein determining a network configuration for each test case further comprises determining one or more of bandwidth, network protocol, frequency band, and network slice for the test case.

13. The system of claim 9, wherein the live network comprises user equipment, a radio, routing equipment, and one or both of a 5G and 4G core service.

14. The system of claim 9, wherein the deep packet inspection probe is a plurality of such probes, with each probe inserted at an interface in the live network.

15. The system of claim 9, wherein the performance profile provided to the developer is a graph or table illustrating a consumption of a network resource by the application during the test case.

16. A set of computer-executable instructions that when executed by one or more programmed electronic processors, cause the processors to evaluate the performance of an application when used with a network configuration by:
obtaining data characterizing an application to be evaluated;
generating one or more test cases for the application based on the data characterizing the application;
determining a network configuration for each test case;
executing each test case in a live network having the specified network configuration;
obtaining data from the execution of the test case using a deep packet inspection probe inserted into the live network;
correlating the obtained data from the execution of the test case to a performance profile for the application; and
providing the performance profile to a developer of the application.

17. The set of computer-executable instructions of claim 16, wherein the data characterizing the application to be evaluated further comprises one or more of a device type, an operating system for the device, a requested network slice type, and whether the application is expected to be bursty, continuous, bandwidth intensive, or latency sensitive with regards to network usage.

18. The set of computer-executable instructions of claim 16, wherein the instructions further cause the one or more electronic processors to generate a test case profile from the data characterizing the application, and the test case profile is generated using a trained model.

19. The set of computer-executable instructions of claim 16, wherein determining a network configuration for each test case further comprises determining one or more of bandwidth, network protocol, frequency band, and network slice for the test case.

20. The set of computer-executable instructions of claim 16, wherein the live network comprises user equipment, a radio, routing equipment, and one or both of a 5G and 4G core service, the deep packet inspection probe is a plurality of such probes, with each probe inserted at an interface in the live network, and the performance profile provided to the developer is a graph or table illustrating a consumption of a network resource by the application during the test case.
